(19) United States
(12) Patent Application Publication
(10) Pub. No.: US 2015/0213722 A1
(43) Pub. Date: Jul. 30, 2015

(54) SYSTEM AND METHOD FOR MOBILE AND RELIABLE TESTING, VOTING, AND/OR LEARNING

(71) Applicant: John Nypl, Foresthill, CA (US)

(72) Inventors: John Nypl, Penryn, CA (US); Justin Carroll, Shirley, MA (US)

(21) Appl. No.: 14/594,110

(22) Filed: Jan. 10, 2015

Related U.S. Application Data
(60) Provisional application No. 61/964,650, filed on Jan. 8, 2014.

(51) Int. Cl. G09B 3/00; G07C 13/00

(52) U.S. Cl. CPC G09B 3/00; G07C 13/00

(57) ABSTRACT

Exemplary embodiments of a system and/or a method for high stakes mobile, reliable, and/or secure testing, voting, and/or learning are described; which may comprise a server, a proxy server, a monitoring device, an interactive device, and/or a command device—all of which may be mobile and battery powered, except for the server. All data or substantially all data may be stored encrypted on the proxy server during the session and transmissions of data may be encrypted. Content delivery to interactive devices may be randomized; and/or responses to content (e.g. answers) may be randomized. In some embodiments, the system and/or the method may comprise validation and/or forensics capabilities which may review data, including monitoring data, for possible improprieties. In some embodiments, a proctor may never have access to delivered content and/or to responses to said delivered content during the session, which may minimize possibility for proctor conflict of interest.

### PRIORITY NOTICE

The present application claims priority under 35 U.S.C. §119(e) to U.S. Provisional Patent Application Ser. No. 61/964,650 filed on Jan. 10, 2014, the disclosure of which is incorporated herein by reference in its entirety.

### TECHNICAL FIELD OF THE INVENTION

The present invention may relate to systems, methods, and/or devices for utilizing custom, commonly, or commercially available computing devices, some of which may be mobile, running shared applications to administer tests, examinations, quizzes, voting, learning, and/or other related uses in a reliable (e.g. secure) fashion and with conflicts of interest mitigated, but with reduced complexity and/or lower costs than previously known.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Embodiments disclosed herein may relate to systems, methods and/or devices for achieving improved results for purposes, including but not limited to, a shared examination session, a shared instruction session, and/or a shared voting session. Several exemplary embodiments of the present invention may address shortcomings in examination administration that currently exists as disclosed by various references in the related art. Likewise, several exemplary embodiment of the present invention address shortcomings in voting administration that currently exists as disclosed by various references in the related art. Examination administration is discussed first, followed by a discussion of voting administration.

The assessment of an individual's qualification for achievement or knowledge of subject matter in a given area have long been performed using examination procedures whereby a proctor delivers exams to students, examinees, or testing candidates for a large variety of purposes. Examination procedures have historically been proctored by a proctor whereby hardcopy written materials, such as multiple choice answer forms (e.g. Scantron®) and question booklets, are provided to examinees to complete during a limited time period, i.e. an examination session. The proctor typically collects both the examinees' answer responses and well as the question booklets upon an examinee's completion or expiration of the limited time period. The answer responses are evaluated for grading by a grader, who may or may not be the proctor, for determination of how well an examinee performed.

As technology has developed, some examination procedures are now performed electronically such as sitting at a Department of Motor Vehicle (DMV) kiosk whereby the testing examinee may perform examination by selecting answers on graphical user interface (GUI), such as a screen using a keyboard and the exam graded using a processing mechanism in a near real time fashion.

However, with respect to examination administration, many problems currently exist relating to test question security, cheating, proctor conflict of interest, promptness of examination results, sign-in registration issues, possible privacy breaches of examinee personal and private information, and uniformity of examination for repetitive tests and/or concurrent but geographically separated testing administration. Each of these problems is briefly discussed below.

Test question security is related to cheating in that if an examinee may know questions in advance or because a question has been repeated, such examinees receive an unfair advantage and thereby defeat the purpose of administering examinations in the first place. In any event, it is desirable to protect a given bank or batch of exam questions from unauthorized access or disclosure until a time of an examination. Furthermore, it is desirable to prevent exam questions administered in current or previous exams, from being copied or otherwise transferred, either by examinees or by a proctor, to be utilized to subsequently give other future examinees an unfair advantage. Additionally, protection of examinee personal data such as names, dates of births, social security numbers, addresses, phone numbers, email addresses, scores, qualifications, and other personal data and information may be a key issue that must be maintained in privacy and confidence at all times, without unnecessary risk of breach of examinee privacy.

Currently, exam question security may be accomplished in various ways, such as keeping questions sealed in envelopes until ready for an examination session, collecting hardcopies of serialized questions at the end of an examination session, and using encryption technology for computer based examinations.

Cheating by examinees may occur individually or by groups of examinees in collusion, with other examinees and/or with others, such as proctors. Therefore, it may be desirable that exams be administered in a way which minimizes examinee cheating and/or provides mechanisms for discovering cheating by examinees when it occurs.

Historically, the possibility of cheating may be largely dealt with by providing instructions to examinees prior to beginning an exam of what behavior may be appropriate and what behavior may be inappropriate. For example, testing subjects are commonly told not to talk during an exam, nor to discuss an exam during a break in the examination, nor look at other examinee materials, nor pass communications, etc.

Additionally proctors for various reasons may have a conflict of interest with respect to a given examination session. For example, the proctor may also be the instructor in which case the instructor may carry biases, whether conscious or unconscious, to have certain students excel in examination and/or to have other students perform poorly. Currently, this problem may be handled by using proctors which in theory have no interest in a given exam session. For example, Professor A might administer Professor B's exam to Professor's B's class, while Professor B does the same for Professor A.

However, even when independent proctors are used to administer an exam, there remains a possibility that a given independent proctor may be encouraged to facilitate cheating or other improprieties. For example, an examinee might bribe such an independent proctor. Or some third party who has an interest in learning the test questions might bribe an independent proctor to learn or gather information and intel. Professional and/or vocational license and/or certification (registration) exams may cost significant amounts of money (hundreds or thousands of dollars in some) and as such, in each developed nation, professional license examinations are big business and also as such, the pressure to gain intel relating to administered questions may be quite high and may entail quite significant coercion (e.g. bribes) to satisfy that high pressure.

It would be desirable to provide examination systems, methods, and/or devices which may overcome this problem of proctor conflict of interest.

Additionally, many examination platforms still utilize paper based systems which are inherently slower than electronic computer based examination platforms. Furthermore, some examination platforms still utilize mailing in of completed test forms to be graded at some off-site location which further increases delays in an examinee receiving taken examination results.

It would be desirable to provide examination systems, methods, and/or devices which may provide near instantaneous results to examinees at the close of an examination session.

Further, in many examination scenarios it may be necessary to verify identity of the examinee, e.g., with professional licensing examinations. This problem may become compounded when independent proctors are used because such independent proctor generally will not and should not know any of the examinees. This problem may be more likely when the number of examinees may be large and/or few examinations may be given on a yearly basis. For example, state bar examinations may be given only twice a year and may include thousands of examinees.

Currently, this issue is addressed by registration or sign-in stations where proctors verify examinee's identities and/or any other required credentials prior to being admitted into an examination area. In some cases examinees may be provided a temporary credential that they are to display or maintain with them during an examination session. This historical approach is time consuming. As the number of examinees increases, more time is required to register and/or sign-in the examinees.

Accordingly, it is desirable to utilize examination systems, methods, and/or devices to provide faster and more efficient examinee registration and/or sign-in (check-in), which may include examinee identity verification.

Similar issues are encountered in voting forums, as in many respects, voting may be categorized as a form of examination, where voters replace examinees and administrators replace proctors, and the examination instead of testing a subject area, still asks questions, but instead is looking for voter preferences with respect to candidates for office and issues to be decided. Voting may be for political and/or governmental reasons. Voting may be for private sector reasons, such as electing directors to a corporation.

For example, when an election is held, a voter must generally be pre-registered and then verified as the appropriate person at the polls by, for example, showing identification or billing statements with the name that matches the list at the polling place. This process is very tedious and can be defeated by mail-in votes or political preferences of the polling agents, etc.

Additionally, testing or voting platforms, methods, and systems in current use generally require specialized, and consequently very expensive, equipment that may only be utilized occasionally, i.e., when examinations are administered or voting is performed. This specialized equipment is designed to prevent or reduce fraudulent behavior of examinees/voters and generally requires verification at every occasion before or after a test or vote to ensure it is working properly.

Additionally, such exams may generate a vast amount of ancillary data to validate, evaluate, review, audit, and the like, which creates new problems of how to efficiently handle validation, evaluation, review, and/or auditing of large amounts of data. It would be desirable if user interactions in a given session may be automatically linked to session monitoring data (e.g. video and audio) to expedite validation, evaluation, review, auditing, and the like.

Embodiments of the present invention overcome or mitigate many of the previously identified issues of the prior art testing or voting solutions. It is to mitigating against these and other problems in the art that various embodiments of the present invention has been developed.

### BRIEF SUMMARY OF THE INVENTION

To minimize the limitations in the prior art, and to minimize other limitations that will be apparent upon reading and understanding the present specification, various embodiments of the present invention may describe systems, methods, and/or devices for utilizing custom, commonly or commercially available computing devices, some of which may be mobile, running shared applications to administer tests, examinations, quizzes, voting, learning, and/or other related uses in a reliable, secure fashion and with conflicts of interest (bias) mitigated, but with reduced complexity and/or at lower costs.

Various embodiments of the present invention may provide systems and/or methods for administering exams (testing solutions application); administering voting sessions (voting solutions application); for administering content to be learned (learning applications); and the like. The testing salutations applications and the voting solutions application may share the same hardware and software, with only the delivered and/or administered content changing.

Additionally, the various hardware and software that may comprise the system and/or the method may be deployed in various configurations to satisfy different needs for mobility, reliability, and/or security. Such deployment configurations may be categorized as high stakes, mid stakes, and low stakes; and/or may be categorized as a spectrum with high stakes on one end and low stakes on the opposing end of said spectrum. High stakes may be in reference to when the highest levels of reliability and/or security may be needed or desired. And low stakes may be in reference to when minimal reliability and/or security may be need or desired. For example, and without limiting the scope of the present invention, an example of a high stakes need may be for a professional licensing exam; whereas, an example of a low stakes need may be a pop-quiz administered in a secondary school classroom.

For example, and without limiting the scope of the present invention, high stakes embodiments, may comprise at least one server, at least one proxy server, at least one monitoring device (e.g. a camera), at least one interactive device (e.g. a tablet), and/or possibly at least one command device (e.g. a different tablet)—all of which may be mobile and battery powered for a duration of the session, aside from the at least one server. Additionally, in some of the high stakes embodiments, all data or substantially all data (e.g. exam data) may be stored encrypted on the proxy server during the session and transmitted while encrypted. Additionally, in some of the high stakes embodiments, content delivery to interactive devices may be randomized; and/or responses to content (e.g. answers) may also be randomized. Additionally, in some of the high stakes embodiments, the system and/or the method may comprise validation and/or forensics capabilities which may review data, including monitoring data for possible improprieties. Further, in some of the high stakes embodiments, a proctor may never have access to delivered content and/or to responses to said delivered content, which may minimize or eliminate the possibility for proctor conflict of interest (bias).

In contrast, in some mid to low stakes embodiments, the system and/or the method may not comprise deployment of the proxy server. Instead content may be delivered directly to interactive devices (e.g. tablets). Such delivered content may be stored on the interactive device for a duration of the session. Sessions may be administered by aid of native operating systems over a wireless connection (e.g. WiFi (Wi-Fi)), wherein the interactive devices connect to the cloud (e.g. internet) to reach a controlling server. Such mid to low stakes sessions may be administered using HTTP/S technology (e.g. with HTML coding).

Some embodiments of the present invention may relate to providing comparably inexpensive, efficient and reliable examination systems, methods, and/or devices which may provide security for a given exam's question bank (and question batch), mitigate the examinees, proctors, or third parties from learning of or possessing a given set of examination questions and rapid easy adaptation of testing questions to prevent fraudulent behavior of examinees and/or proctors from decreasing the reliability of testing or voting by disclosing testing questions to others.

It is an objective of the present invention to provide a system and/or method which may be configurable for deployment into a variety of physically different shaped administration locations.

It is another objective of the present invention to provide a system and/or method which may be configurable for deployment into different geographically diverse administration locations.

Another objective of inventive embodiments discussed herein may be to provide examination systems, methods, and/or devices which may mitigate the possibility of examinee cheating as well as provide a means for post-examination review of an examination setting to find examinees who may have cheated on an exam.

It is another objective of the present invention to provide examination/voting systems, methods, and/or devices which may reduce or eliminate concerns with respect to proctor conflicts of interest, such that an exam may be administered in a secure fashion regardless of proctor conflict of interest. That is, to reduce the control or influence a proctor or voting agent (administrator) may use to influence outcomes of a given exam or vote.

It is another objective of certain embodiments of the invention to present invention to provide examination/voting systems, methods, and/or devices which may provide near instantaneous examination/voting results feedback (e.g. grades, scores, results, and/or statistics) to both examinees/voters and other persons of interests, such as instructors, certification bodies, licensing bodies, and the like.

Other objects of the inventive embodiments may provide examination systems, methods, and/or devices which may provide faster and more efficient manner examinee registration and/or sign-in (check-in), which may include examinee identity verification; and/or the ability to receive examinees' signatures and/or capture various biometric information, such as current photograph, fingerprint, and/or voice recording of examinees.

Other objects of the inventive embodiments may provide examination systems, methods, and/or devices which may provide examination uniformity with respect to different exams given over different time periods, but wherein an overall subject matter being tested may be the same.

Other objects of the inventive embodiments may provide examination systems, methods, and/or devices which may provide examination uniformity with respect to different exams given over a same time period but in different geographical locations.

It is yet another objective of the present invention to provide controlled and predetermined content to be learned to students and other persons of interests, wherein such content may be pushed (delivered) by various inventive mobile and reliable and/or secure systems, methods, and/or device embodiments.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 may depict deployment of aspects of a system and/or a method for mobile, reliable, and/or secure testing, voting, and/or learning, wherein a session (e.g., an exam session, a voting session, and/or a learning session) may be conducted in an environment, wherein the environment may be a L-shaped room, all shown from a top view.

FIG. 2 may depict a block diagram of servers, at least one proxy server, and various devices all depicted with various communication relationships, wherein various web-based services and/or various deployed configurations of the various devices may be used for mobile, reliable, and/or secure testing, voting, and/or learning.

FIG. 2A may depict a block diagram of at least one server, at least one proxy server, at least one command device, and at least one client device, all depicted with various communication relationships, such that mobile, reliable, and/or secure testing, voting, and/or learning may be carried out.

FIG. 2B may depict a block diagram of at least one server, at least one proxy server, and at least one client device, all depicted with various communication relationships, such that mobile, reliable, and/or secure testing, voting, and/or learning may be carried out.

FIG. 2C may depict a block diagram of at least one server, at least one command device, and at least one client device, all depicted with various communication relationships, such that mobile, reliable, and/or secure testing, voting, and/or learning may be carried out.

FIG. 2D may depict a block diagram of at least one server, at least one command device, and at least one client device, all depicted with various communication relationships, such that mobile, reliable, and/or secure testing, voting, and/or learning may be carried out.

FIG. 3 may depict a block diagram of at least one server in communication with at least one computing-device, such that various web-based services may be carried out.

FIG. 4A may depict an organizational structure for how various users of the system and/or the method may be categorized.

FIG. 4B may depict the various users of FIG. 4A in how such users may be related as depicted in a Venn diagram.

FIG. 5 may depict an organizational structure for how data used in the system and/or the method may be categorized.

FIG. 6 may depict a flow chart of exemplary global steps in the method and used by the system.

FIG. 7A, FIG. 7B, and FIG. 7C may depict a single flow chart, divided into three consecutive figures, wherein the single flow char may depict exemplary global steps in the method and used by the system.

FIG. 8 may depict deployment of aspects of a system and/or a method for mobile and reliable voting, wherein a voting session may be conducted in a voting environment, wherein the voting environment may be an isolated room, all shown from a top view.

### SCHEDULE/LISTING OF REFERENCE NUMERALS

101 environment 101 (e.g. exam environment 101)
102 front of environment 102
103 back of environment 103
110 command device 110 (e.g. at least one command device 110)
150 interactive device 150 (e.g. at least one interactive device 150)
150a tablet computing interactive device 150a
150b laptop interactive device 150b
150c interactive device with input device 150c
150d personal computer (PC) interactive device 150d
175 standalone camera 175
176 angle of view 176
177 integral-camera 177
178 wearable-camera 178
201 server 201 (e.g. at least one server 201)
210 proxy server 210 (e.g. at least one proxy server 210)
220 computing-device 220
230 server access station 230
240 client device 240 (e.g. at least one client device 240)
251 communication pathway 251
252 communication pathway 252
253 communication pathway 253
254 communication pathway 254
255 communication pathway 255
256 communication pathway 256
257 communication pathway 257
260 network 260
358 communication pathway 358
401 users 401
410 interactive device user 410
411 examinee 411
412 voter 412
413 student 413
414 attendee 414
420 command device and/or proxy server user 420
421 proctor 421
422 administrator 422
423 instructor 423
430 customer 430
431 third Party 431
432 writer 432
433 grader 433
435 interested Party 435
436 auditor 436
450 system admin 450
501 data 501
510 question bank 510 (e.g. at least one question bank 510)
511 predetermined question 511 (e.g. at least one predetermined question 511)
512 question batch 512 (e.g. at least one question batch 512)
550 exam data 550
555 answer 555 (e.g. at least one answer 555)
560 metadata 560
561 user info 561
563 device info 563
570 monitoring data 570
580 check-in data 580
590 tamper data 590
601 web-bases services 601
602 server side 602
605 receive request for exam 605
607 are proctor's available 607
608 register proctor 608
609 is exam build 609
610 build exam 610
615 schedule exam 615
620 register examinees 620
625 prepare for exam 625
627 deliver exam question batch 627
628 physical exam site setup and check 628
630 exam check-in 630
635 exam session conducted 635
637 monitor exam 637
640 receive exam data 640 (e.g. receive exam responses meta data and/or monitoring 640 data 640)
645 validate exam 645
650 provide exam feedback 650
701 receive custom request 701
702 customer currently exist 702
703 link content 703
704 physical site available 704
705 link session to site 705
706 registration for session 706
707 proctor's available 707
708 build content 708
709 select location 709 or select virtual location 709
710 register proctors 710 or assign proctors 710
711 prepare for exam 711
712 pre exam confirmations 712
713 start session 713
714 session monitoring 714
715 optional pause and resume 715 (e.g. optional stop and restart 715)
716 conclude exam testing 716
717 provide exam feedback 717
718 session monitoring data generation and collection 718
719 remote user log in 719
720 remote monitoring 720
721 data archive 721
722 data receipt by proxy server 722 or data delivery to device 722
725 data upload 725
726 confirm receipt of data upload 726
727 exam data all received 727
728 validation, grading, analytics, and/or statistics 728
729 delete data on proxy and/or devices 729
730 conclude session 730
731 store data on proxy and/or device 731
732 store data on proxy and/or device 732
733 attempt resend of data to server 733
750 monitoring devices (audio/visual) 750
751 secure proxy 751 (equivalent to proxy server 210 in some embodiments)
753 isolated environment for private voting 753 (e.g. booth 753)
754 optional control device 754 (equivalent to command device 110 in some embody ments)

### DETAILED DESCRIPTION OF THE INVENTION

Various methods, systems, and/or devices for mobile, reliable, and/or secure testing, voting, and/or learning may be described and disclosed. “Mobile” as used above may be respect to that in some embodiments, deployment of the system and the method may be configurable for use in diverse locations (geographically diverse); different shaped locations, including indoors and outdoors; as well as temporally diverse session administration.

By way of introduction from a global perspective, and without limiting the scope of the present invention, various embodiments of the system and/or the method may comprise delivering known or predetermined content (e.g. at least one question) from at least one server to at least one client device (e.g. a tablet) across a network; and then subsequently at least one server may receive responses to the predetermined content from the at least one client device. The content may be selected from the group comprising examination questions testing subject matter; voting questions; and/or lecture/seminar/webinar information presented for learning; and the like. Both the delivery from the at least one server and the receiving by at least one server (which may be a different server), may be done reliably and/or securely, i.e. with transmitted data encrypted and/or data integrity verified for completeness. Additionally, where higher reliability and/or security may be desired or needed, an intermediary device, a proxy server may be used between the at least one server and the at least one client device. Additionally, during a session administration (e.g. exam session, voting session, and/or learning session)—both the physical environment and the progression of presented content and receipt of responses to content—may be monitored in real-time or near real-time, by at least one monitoring device. In terms of the physical environment, examinees, proctors, voters, administrators, learners, students, teachers, professors, instructors, and any other person present within the environment may all be reliably and/or securely monitored with various client devices comprising various monitoring devices, which may then comprise: a camera, a standalone camera; a microphone; a camera combined with a microphone; a standalone monitoring device; a mountable monitoring device; a wearable monitoring device; integral monitoring devices integral with an interactive device and/or command device; other sensors; and the like.

Additionally, the at least one server, may also provide a variety of web-based services, both on a front-end and at a back-end. For example, and without limiting the scope of the present invention, on the front-end, various users of the methods, systems, and/or devices may: request examinations; build exams; register proctors; register examinees; schedule examines; conduct some examination preparation; request voting; build a vote question bank; register voters; register voting administrators, conduct some voting preparation; update various user accounts and preferences, and the like.

For example, and without limiting the scope of the present invention, on the back-end, various users of the methods, systems, and/or devices may: conduct some examination validation; grade exams; determine which exam validation, grading, and other statistics may be presented, including determining who may access such.

In terms of users of the methods, systems, and/or devices, such users may comprise: interactive device users; command device and/or proxy server users; third parties; interested parties; system admin; and the like.

For example, and without limiting the scope of the present invention, interactive device users may comprise: examinees, voters, students, learners, attendees, and the like.

For example, and without limiting the scope of the present invention, command device and/or proxy server users may comprise: proctors, administrators, teachers, instructors, professors, lecturers, and the like. In some embodiments, with respect to a particular subject matter, interactive client device users may be a mutually exclusive group with command device and/or proxy server users.

For example, and without limiting the scope of the present invention, third parties may comprise: school districts, colleges, universities, private schools, charter schools, public schools, companies, municipalities, certification bodies, licensing bodies, and the like. In some embodiments, the third parties may be responsible for generating the content. In some embodiments, the third parties may be responsible for requesting and/or scheduling exams, votes, lectures, webinars, seminars, and the like. In some embodiments, there may be overlap with third parties and command device and/or proxy server users. For example, and without limiting the scope of the present invention, a proctor may be an employee or agent of a given third party.

For example, and without limiting the scope of the present invention, third parties may comprise: school districts, colleges, universities, private schools, charter schools, public schools, companies, municipalities, certification bodies, licensing bodies, and the like. In some embodiments, an interested party may have an interest in responses to delivered content, e.g., an interest in exam scores or grades. For example, and without limiting the scope of the present invention, a parent of an examinee might be an interested party. In some embodiments, there may be overlap with third parties and interested parties. For example, and without limiting the scope of the present invention, a school district might be both a third party and an interested party.

In some embodiments, system admin users may be those who actively maintain the methods, systems, and/or devices. In some embodiments, system admin users may be technicians and engineers. In some embodiments, system admin users may be employees, consultants, independent contractors, and/or agents of an entity charged with maintaining the methods, systems, and/or devices. In some embodiments, there may be overlap with system admin users and interested parties, with third parties, and/or with command device and/or proxy users.

In some embodiments, all users may have a user-account. In some embodiments, logging into a user-account may require entry of a username and password. In some embodiments, each user-account depending upon type of user may have different permissions and different functionality associated with the given user-account.

In terms of distinct hardware components, the method and/or system may comprise: at least one server, at least one proxy server (not utilized in some embodiments, e.g. lower stakes embodiments), at least one command device (not utilized in some embodiments), at least one client device (may comprise at least one interactive device and/or at least one monitoring device), at least one computing-device, at least one server access station, and the like. Communications between any two of these hardware components may be by wireless and/or wired communication. Additionally, such communications may be across a network. The network may be the internet, a wide area network (WAN), and/or a local area network (LAN). In some embodiments, the at least one proxy server, the at least one interactive device, at least one monitoring device, and/or the least one command device may form a LAN. In some embodiments, the at least one server and the at least one server access station may form a LAN.

In addition to, the at least one server, the at least one proxy server (not utilized in some embodiments), the at least one command device (not utilized in some embodiments), and the at least one client device, to facilitate communication across the network, the method and/or system may also comprise modems, routers, access points (e.g. hotspots), and/or combined modem-router-access points. In some embodiments, such modems, routers, access points may also be integrated within the at least one server, the at least one proxy server (not utilized in some embodiments), the at least one command device (not utilized in some embodiments), and the at least one client device. For example, all four devices may comprise at least one network card, which may be configured for performing functions associated with modems, routers, and/or access points.

In some embodiments, command devices may be used to: register examinees; check-in examinees; initiate delivery of exam questions to the at least one proxy server and/or to at least one interactive device; start an examination session; observe real-time feeds from monitoring devices, including integral monitoring devices integral to interactive devices in some embodiments, tracking time for the examination session; conclude the examination session by facilitating receipt of examination session responses, metadata, and/or monitoring data to the at least one server; and the like. In some embodiments, the at least one command device may comprise tablet-computing-devices (tablets), laptops, personal computers (PCs), desktop computers, phones (smartphones), watches (smartwatches), and/or any other mobile computing device. In exemplary embodiments, the command device may be a mobile computing device, such as a tablet. In exemplary embodiments, tablets may be a predominant command device. In some exemplary embodiments, the command devices may be battery powered. In some embodiments, command devices may be used by command device and/or proxy server users, such as proctors, administrators, teachers, instructors, professors, lecturers, and the like. In some exemplary embodiments, to prevent proctor and/or administrator conflicts, command devices may be not be able to access/visualize questions nor responses to questions. In some embodiments, there may be command device used. In some embodiments, the command device may integrated with the proxy server.

In some embodiments, client devices may comprise at least one interactive device, at least one monitoring device, and the like.

In some embodiments, the at least one interactive device may comprise tablets, laptops, PCs, desktop computers, phones (smartphones), watches (smartwatches), and/or any other mobile computing device. In exemplary embodiments, the interactive device may be a mobile computing device, such as a tablet. In exemplary embodiments, tablets may be a predominant interactive device. In some exemplary embodiments, the interactive devices may be battery powered. In some exemplary embodiments, the interactive devices may be used by the interactive device users, such as examinees, voters, students, learners, attendees, and the like. In some exemplary embodiments, the interactive devices may be used by the interactive device users to enter responses to various content, such as responding to questions.

In some embodiments, monitoring devices may be used to monitor an exam environment (exam setting) and/or exam check-in (sign-in), in real-time or near real-time. The step of monitoring may occur during exam check-in and/or during the exam session. When monitoring may be active it may run continuously. In some embodiments, monitoring devices may comprise cameras, microphones, and/or other sensors. In some embodiments, a camera, a microphone, and an other sensor, may each be a standalone monitoring device. In some embodiments, an integrated monitoring device may comprise a camera, microphone, and other sensors within a single integrated monitoring device. For example, and without limiting the scope of the present invention, an integrated monitoring device may comprise a RBG camera, an IR emitter, an IR camera, and a microphone. Such IR (infrared) components may be used to create a dynamic depth map or dynamic 3D recording of a field of view. In some embodiments, both standalone and integrated monitoring device may be used. In some embodiments, the monitoring devices may be removably mountable to various articles. Such articles may comprise tripods, walls, ceilings, floors, desks, and the like. In some embodiments, the monitoring devices may be removably wearable, i.e. removably mountable to various clothing articles and/or accessories, such as glasses, lapels, collars, shirts, blouses, necklaces, ID badges, and the like. In terms of quantity, enough monitoring devices may be used to provide comprehensive monitoring of all persons located within a physical examination setting (either from multiple geographically different locations or a singular geographic location), which may be indoors or outdoors (or a combination of indoors and outdoors).

Note, some interactive devices and/or some command devices may also comprise integrated monitoring devices. For example, and without limiting the scope of the present invention, tablets, laptops, PCs, desktop computers, phones (smartphones), watches (smartwatches), and/or any other mobile computing device may comprise cameras, microphones, and other sensors. For example, and without limiting the scope of the present invention, tablets may comprise a front facing and a rear facing camera, as well as a microphone, and in some embodiments, an other sensor, such as an ability to scan for fingerprints. Such monitoring devices integral to some interactive devices and/or some command devices may be used in various embodiments, e.g., with monitoring the exam environment (exam setting) and/or with facilitating and monitoring exam check-in (sign-in), in real-time or near real-time.

In some embodiments, the system and/or the method may also comprise use of at least one SD (secure digital) card for temporary, but non-transitory data (e.g. of exam data) storage. The SD card may be a flash memory card configured to provide high-capacity memory in a small size. Such SD cards may be used in any of the client devices, including the interactive devices and/or the monitoring devices. Data saved to a SD card may be encrypted to enhance security and protect privacy.

With respect to software (running on any of the hardware elements) including executable code and/or proxy executable code—such software in some embodiments may be commercially available off the shelf software.

For example, and without limiting the scope of the present invention, in some embodiments the operating systems used herein may be commercially available off the shelf operating systems such as various UNIX based operating systems (e.g. LINUX), WINDOWS, and/or MAC operating systems.

For example, and without limiting the scope of the present invention, in some embodiments the software associated with facilitating communication (e.g. wireless and/or wired communications) between different devices may be commercially available off the shelf software; and in some instances may be provided the operating software. Such commercially available software may also include providing chat functionality between an interactive device and command device; or between interactive device and a server access station (operated by system admin) in communication with the server. Including a chat function, may encourage examinees to remain seated, which may minimize distractions and possibility for improprieties.

For example, and without limiting the scope of the present invention, in some embodiments the software associated with encrypting and decrypting data may be commercially available off the shelf software.

For example, and without limiting the scope of the present invention, in some embodiments the different software associated with interpreting and/or analyzing monitoring device data may be commercially available off the shelf software.

For example, and without limiting the scope of the present invention, in some embodiments the different software associated with interpreting and/or analyzing input device data (e.g. touchscreens, mice, keyboards, and the like) from interactive devices and/or command devices may be commercially available off the shelf software.

In some embodiments, there may also be some custom software. For example, and without limiting the scope of the present invention, such custom software may be responsible for the data flagging and alerting, validation, forensics, auditing, grading, content building, and the like.

In some embodiments, the custom software solutions may be combined with the commercially available off the shelf software solutions and integrated with additional custom software.

For example and without limiting the scope of the present invention, either custom software or commercially available software may be used to control integrated input devices associated with interactive devices, such as, but not limited to, volume control buttons, home buttons, front facing cameras, rear facing cameras, integral microphones, touchscreens, and the like. Such control by the system and/or the method may permit greater control over an administered session by controlling starting and stopping of timers; starting and stopping of applications running on the devices themselves; performing photo, video, audio, swiping, and/or keystroke typing capture. For example, and without limiting the scope of the present invention, a devices integral home button may be temporarily (for the duration of the session) reprogrammed to initiate screen shot capture functionality.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

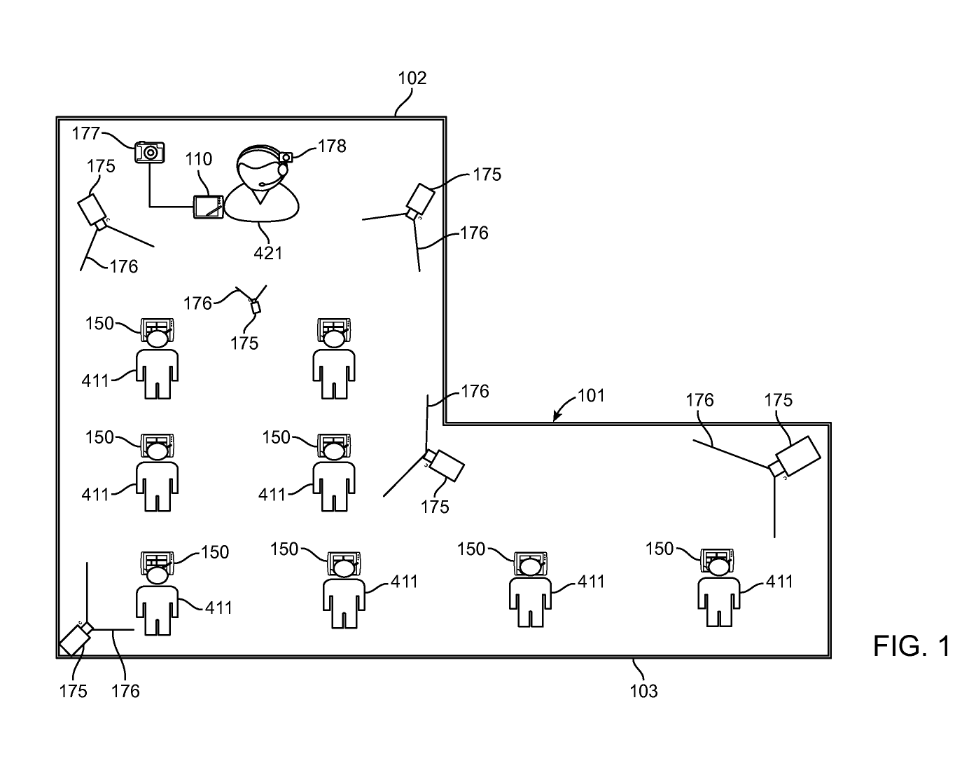

FIG. 1 may depict deployment of aspects of a system and/or a method for mobile, reliable, and/or secure testing, voting, and/or learning. A session (e.g., an exam session, a voting session, and/or a learning session) may be conducted in an environment 101. In FIG. 1, a shape of environment 101 may be an L-shaped room, all shown from a top view.

In FIG. 1 an exam session while being administered may be depicted. A proctor 421 may be stationed at a front of environment 102 and a plurality of examinees 411 may be located within environment 101. Each examinee 411 may be using one interactive device 150 to read, see, and/or hear presented predetermined questions 511 and may then respond to such predetermined questions 511 by providing an answer 555 to each predetermined question 511. Answers 555 may be input into interactive device 150. In some embodiments, interactive device 150 may comprise a tablet computing device (tablet) 150a, a laptop 150b, a personal computer (PC) 150d, a desktop computer, a smartphone, a smart watch, an interactive device with input device 150c, and the like.

Likewise, each proctor 421 may be using one command device 110. In some embodiments, command device 110 may comprise a tablet computing device (tablet), a laptop, a personal computer (PC), a desktop computer, a smartphone, a smart watch, an interactive device with input device, and the like. In some embodiments, command device 110 may be used to access (view) image feeds and other sensor feeds from various monitoring devices located within environment 101. For example, and without limiting the scope of the present invention, proctor 421 may use command device 110 to access various standalone cameras 175 positioned in or around environment 101 to view various examinees 411, including those examinees 411 who may not otherwise be in a direct line of sigh with proctor 421, e.g. examinees 411 located at back of environment 103.

Note also, that the various standalone cameras 175 may be positioned to not only monitor examinees 411, but also to monitor proctor 421. See e.g., FIG. 1. This may reduce proctor 421 bias and/or catch proctor 421 bias or other impropriety if it occurs.

Each interactive device 150 and/or each command device 110 may comprise one or more integral monitoring devices. Such integral monitoring devices may be selected from one or more of the group comprising: at least one front facing camera, at least one rear facing camera, at least one integral microphone, at least one gyroscope and/or accelerometer, at least one GPS circuit, pixel counter, pixel tracker, media screen capture, typing tracking, eye tracking, facial recognition, auditory recognition, EEG sensor, heartrate sensor, breath rate sensor, proximity devices, at least one means for reading at least one fingerprint, and the like. In FIG. 1, integral camera 177 may be depicted in association with command device 110. Note, while integral camera 177 may be shown some distance from command device 110 in FIG. 1, this may be purely to aid in showing these elements, i.e. in reality integral camera 177 may be integral with command device 110. Integral camera 177 may be front facing or rear facing. Each interactive device 150 may also include an integral camera 177 and/or other integral monitoring devices as noted above.

Note, in FIG. 1 while an L-shaped environment 101 may be depicted, other physical shapes for environment 101 may be used equally well with various embodiments of the system and/or the method. One reason for depicting L-shaped environment 101 in FIG. 1 may have to demonstrate effective operation of the system and/or method in a room wherein proctor 421 may not have personal direct line of sight with some examinees 411 present during the exam session, e.g. some examinees 411 located proximate to back of environment 103. Exam environments 101 which may prevent proctor 421 direct line of sight of all examinees 411 may still be conducted in reliable and/or secure manner, with minimal chances for cheating and/or proctor 421 bias by using various embodiments of the system and/or the method.

In addition, various embodiments of the system and/or method may permit reliable and/or secure, testing, voting, and/or learning in indoor or outdoor environments 101. Thus various embodiments of the system and/or method may be also be used for practical type examinations, i.e. where examinees 411 may move from testing station to another.

Note, while a proctor 421 to examinee 411 ratio of 1:8 may be depicted in FIG. 1, various embodiments of the system and/or the method may be scalable up or down with respect to proctor to examinee ratio.

Additionally, each examinee 411 in FIG. 1 may be standing or located at a desk, table, bench, cubicle, booth, and the like. Additionally, each examinee 411 in FIG. 1 could be replaced with a voter 412; and proctor 421 could be replaced with administrator 422 for a voting session embodiment. Hardware could remain the same in a voting session application of the system and/or the method, i.e. at least one command device 110, one interactive device 150 for each user, a plurality of standalone cameras 175, plurality of integral cameras 177 associated with each command device 110 and with each interactive device 150, and a wearable camera 178 associated with each administrator 422. In some embodiments, wearable cameras 178 may also be associated with examinees 411.

In some embodiments, the system and/or the method may comprise at least one client device 240. In some embodiments, the at least one client device 240 may be selected from one or more of the group comprising: at least one interactive device 150, at least one monitoring device, and the like. In some embodiments, at least one interactive device 150 may be used for facilitating exam check-in 630 and/or for facilitating display of the at least one predetermined question 511 along with facilitating receiving an input from an examinee 411 to act as the least one answer 555. In some embodiments, the at least one monitoring device may be used for facilitating exam check-in 630 and/or for facilitating examinee 411 and/or proctor 421 monitoring during the exam session. Monitoring devices shall be discussed next, then followed by a discussion of interactive devices 150, and then followed by a discussion of client devices 240, which may be applicable to either or both monitoring devices and interactive devices 150.

With respect to reliability and/or security, various embodiments of the system may comprise at least one monitoring device for facilitating exam check-in 630 and/or for facilitating examinee monitoring during the exam session. As noted, in some embodiments, monitoring devices may be a sub-set of client devices 240, wherein client devices 240 may comprise monitoring devices, interactive devices 150, and the like.

In some embodiments, the monitoring device may be selected from one or more of the group comprising: a camera, such as standalone camera 175; a microphone; a camera combined with a microphone; a standalone monitoring device; a mountable monitoring device; a wearable monitoring device; and the like. In some embodiments, data generated from and received from the camera, the microphone, and/or the camera combined with the microphone, and/or other monitoring devices may be denoted as monitoring data 570. In some embodiments, standalone camera 175 may comprise a microphone. In some embodiments, standalone camera 175 may comprise a speaker. In some embodiments, standalone camera 175 may comprise a microphone and a speaker. The speaker may permit proctor 421 to provide various instructions to examinees 411 and/or announcements.

In some embodiments, the camera or any camera noted herein (including integral cameras), including standalone camera 175, may record in color (e.g. RBG), black and white, and/or infrared (IR). In some embodiments, the camera or any camera noted herein (including integral cameras), including standalone camera 175, may comprise an infrared (IR) emitter. Such a camera may record dynamic, real-time, and/or three dimensional (3D) data by receiving reflected infrared (IR) signals (reflections) from various objects within the camera's field of view. Software (which may be commercially available off the shelf software) operating on the camera, at least one proxy server 210, command device 110, and/or at least one server 201 may construct a dynamic, real-time, three dimensional (3D) video of the camera's field of view recorded during an exam session. Use of one or more dynamic, real-time 3D videos of an exam environment 101 may be used to detect various proctor 421 and/or examinee 411 improprieties, including possible cheating or bias.

In some embodiments, the system and/of the method may comprise at least a quantity of monitoring devices, e.g., standalone camera 175, such that every proctor 421 and every examinee 411 planned to be substantially within the exam environment 101 during the exam session may reside within at least one monitoring device's zones of operation. For camera's a zone of operation may be the camera's field of view, which may in turn be defined by an angle of view 176 (see e.g., FIG. 1). For example, and without limiting the scope of the present invention, in some embodiments, angle of view 176 may range from 10 degrees (e.g. telephoto lens) to 180 degrees (e.g. fisheye lens). For microphones the zone of operation may be a range in which various sounds may be detected and/or the zone of operation may be a range of sound energy (e.g. in decibels) capable of being picked up by the microphone.

Note, use of “substantially,” in the above paragraph of, “substantially within the exam environment 101 during the exam session” may denote that proctors 421 and/or examinees 411 may come and go during an administered exam for some purposes, e.g. to use a restroom; although in some examinations even this may be limited, controlled, and/or monitored. In addition, in some exam scenarios, proctors 421 may wonder around the exam environment 101 and thus may move from one zone of operation to another as the proctor 421 moves around the exam environment 101. In addition, in some exam scenarios (e.g. “practical” exams), examinees 411 may wonder around the exam environment 101 to different testing stations and thus may move from one zone of operation to another as the examinee 411 moves around the exam environment 101.

In some embodiments, the at least one monitoring device may be positioned such that every proctor 421 and/or every examinee 411 planned to be substantially within the exam environment 101 during the exam session may reside within the at least one monitoring device's zones of operation. Use of “substantially” in the proceeding sentence may be as noted above in the proceeding paragraph. In terms of positioning, the at least one monitoring device may be positioned within the environment 101, around a periphery of environment 101, and/or at a boundary of environment 101.

In some embodiments, in terms of positioning, monitoring devices may be positioned within multiple geographically different environments 101, around peripheries of multiple geographically different environments 101, and/or at boundaries of multiple geographically different environments 101. For example, consider a distributed session where there may be multiple geographically different environments 101 and/or individuals testing in their homes or other remote locations.

In some embodiments, the at least one monitoring device may comprise a mounting means. The mounting means may permit removable attachment of the at least one monitoring device to a tripod, a wall, a desk, a shelf, a chair, a cabinet, a table, furniture, and the like. For example, and without limiting the scope of the present invention, the mounting means may comprise a clamp device, a base (e.g. weighted), a receiving threaded hole (for a bolt or screw), a threaded bolt or screw, VELCRO type fastener (plurality of hooks and complimentary loops), bungee cord, straps, and the like. For example, and without limiting the scope of the present invention, standalone cameras 175 depicted in FIG. 1 may be removably mounted on mobile tripods. For example, and without limiting the scope of the present invention, the standalone camera 175 depicted in FIG. 1 facing proctor 421 may be removably mounted on a mobile tripod or may be placed on top of a desk and/or a table.

In some embodiments, the at least one monitoring device may comprise a wearable means. The wearable means may permit the at least one monitoring device to be removably attached to various articles (e.g. eye glasses) which may be closely associated with a user 401, such as a proctor 421, and/or examinee 411. The article may be an article worn by user 401, such as a proctor 421, and/or examinee 411. For example, and without limiting the scope of the present invention, in some embodiments, the wearable means may permit removable attachment of the at least one monitoring device to articles, wherein the articles may be selected from one or more of the group comprising: eye glasses, clothing, hats, headbands, headsets, headphones, shirts, jackets, sweaters, clothes, garments, necklaces, lanyards, ID cards, collars, lapels, wrists, watches, and the like.

For example, and without limiting the scope of the present invention, as depicted in FIG. 1 proctor 421 may be wearing a headset, with microphone, wherein the headset may also comprise wearable camera 178.

In some embodiments, the wearable means may be integral with the monitoring device. In some embodiments the wearable means may be integral with the article. In some embodiments, the wearable means may be integral with the monitoring device and the article. For example, and without limiting the scope of the present invention, in FIG. 1 the headset that proctor 421 (or another user 401, such as examinee 411 or other users 401) may be wearing may comprise integral wearable camera 178, such that the headset, wearable camera 178, and the microphone are all one integral device being worn by proctor 421. In some embodiments, the wearable means may be removable from the article upon which the wearable monitoring device may be attached to.

For example, and without limiting the scope of the present invention, the wearable means may comprise a clip device, a clamp device, a receiving threaded hole (for a bolt or screw), a threaded bolt or screw, VELCRO type fastener (plurality of hooks and complimentary loops), bungee cord, straps, and the like.

In some embodiments, some or all of anyone present within environment 101 may wear a wearable monitoring device, such as wearable camera 178. For example, and without limiting the scope of the present invention, all or less than all proctors 421 present within environment 101 may wear a wearable monitoring device, such as wearable camera 178. For example, and without limiting the scope of the present invention, all or less than all examinees 411 present within environment 101 may wear a wearable monitoring device, such as wearable camera 178.

In some embodiments, wearable monitoring devices, such as camera 178, may comprise gyroscopes and/or accelerometer, GPS circuits, EEG (electroencephalogram) sensors, proximity devices, and the like.

Wearable mounting devices, such as wearable camera 178, may provide an added layer of security, reliability and may provide additional data streams to analyze which might reveal improprieties.

In some embodiments, wearable monitoring devices may have a data transmission cable connection to an interactive device 150 and/or command device 110, such as, but not limited to, a USB cable or micro USB cable. In other embodiments, communication may occur by wireless means, e.g. by using IP addresses, MAC addresses, WiFi, Bluetooth and other wireless communication protocol suitable for permitting a monitoring device to communicate with interactive device 150 and/or command device 110 (and/or proxy server 210).

In some embodiments, the at least one monitoring device may generate data (e.g. monitoring data 570). Such data may be generated from an integral sensor associated with the monitoring device, e.g., with cameras the integral sensor may be a lens subassembly. Such generated data may be obtained during exam check-in 630 and may be part of check-in data 580. Such generated data may be obtained during the exam session and may be monitoring data 570.

Now turning to a discussion of interactive devices 150. In some embodiments, at least one interactive device 150 may be used for facilitating exam check-in 630 and/or for facilitating display of at least one predetermined question 511 along with facilitating receiving an input from an examinee 411 to act as the least one answer 555. Each examinee 411 may be using one interactive device 150 to read, see, and/or hear presented predetermined questions 511 and may then respond to such predetermined questions 511 by providing an answer 555 to each predetermined question 511. Answers 555 may be input into interactive device 150. In some embodiments, at least one interactive device 150 may receive inputs from an examinee 411 using the at least one interactive device 150. Such inputs may be used to check-in 630 the examinee 411 prior to the exam session, wherein such received inputs may be check-in data 580. Such inputs may be at least one answer 555 to the at least one predetermined question 511 and such received inputs may be a sub-set of exam data 550.

In some embodiments, interactive device 150 may comprise tablet 150a, laptop 150b, PC 150d, a desktop computer, a smartphone, a smart watch, interactive device with input device 150c, and the like. Some such interactive devices 150 may comprise touch interfaces (e.g. touchscreens), which may be used for various assessment, forensics, and auditing purposes.

In some embodiments, an interactive device 150 may be a computing device wherein the device may be capable of displaying at least one predetermined question 511 to examinee 411 using the interactive device 150. Such an interactive device 150 may be capable of receiving an input, i.e. a response to the displayed at least one predetermined question 511. That is, the interactive device 150 may be configured to permit examinee 411 in answering the displayed at least one predetermined question 511. Interactive devices 150 may comprise graphical user interfaces (GUI), such as touchscreens, keyboard, a mouse, a stylus, and other input devices.

In some embodiments, interactive devices 150 may be commercially available and unmodified or un-customized with respect to hardware, wherein what may be custom may be at least some of the software installed on such interactive devices to configure such interactive devices 150 to conforming with the system and/or the method. In some embodiments, such custom software install may be done by command device and/or proxy server users 420, customers 430, system admin 450, and/or interactive device users 410 (e.g. examinees 411, voters 412, students 413, attendees 414, and the like). In some embodiments, interactive devices 150 may be commercially available which may be custom modified, for example with certain integral monitoring devices. In some embodiments, interactive devices 150 may be provided by customers 430, by system admin 450, and/or provided by interactive device users 410 (e.g. examinees 411, voters 412, students 413, attendees 414, and the like).

In some embodiments, at least one interactive device 150 may comprise at least one integral monitoring device; for example, and without limiting the scope of the present invention, integral camera 177. The at least one integral monitoring device may be used for facilitating exam check-in 630 and/or for facilitating examinee and/or proctor monitoring during an exam session. Note, command device 110 may also comprise one or more integral monitoring device.

In some embodiments, at least one interactive device 150 may receive data from integral monitoring devices which may be integral with at least one interactive device 150. Such data received may be obtained during exam check-in 630 and may be check-in data 580. Such data received may be obtained during the exam session and may be monitoring data 570.

In some embodiments, the at least one integral monitoring device may be selected from one or more of the group comprising: at least one front facing camera, at least one rear facing camera, at least one integral microphone, at least one gyroscope and/or accelerometer, at least one GPS circuit, pixel counter, pixel tracker, media screen capture, typing tracking, eye tracking, facial recognition, auditory recognition, EEG sensor, heartrate sensor, breath rate sensor, proximity devices, at least one means for reading at least one fingerprint, and the like. For example, integral camera 177 depicted in FIG. 1 may be an integral monitoring device and may be integral to command device 110, and other integral cameras 177 may be integral to interactive devices 150.

In some embodiments, either randomly or on a scheduled interval determined by customer 430, proctor 421, and/or system admin 450, the system may direct that interactive devices, e.g. using front facing cameras, or table mounted standalone cameras 175 connected to an interactive device 150 to take photos of the cameras field of view. Such photos may be date and time stamped and correlated with the session time—and may be used e.g., for biometrics analysis.

Such integral gyroscopes and/or accelerometer and/or GPS circuits, along with complimentary software may be used track physical movement and location of the interactive device 150. The complimentary software, which may be commercially available off the shelf software, may analyze the inputs received from the gyroscope and/or accelerometer and/or GPS circuit to provide physical movement and/or location determination, with dynamic real-time tracking. In various embodiments, the complimentary software may be running on the interactive device 150, the proxy server 210, the server 201, and/or the command device 110. For example, and without limiting the scope of the present invention, by using standard GPS technologies, all exam data 550 within a session may be tracked to longitude and latitude. Such geo data may permit “geofencing” a session so, exam data 550 received from outside of the geofence may be flagged and/or wherein interactive devices 150 may be paused or deactivated if moved outside the geofence during the exam session.

In addition to gyroscope and/or accelerometer and/or GPS circuits integral with the interactive device 150, or as an alternative, various proximity devices may be integral with the interactive device 150 (and/or with command device 110). In some embodiments, such proximity devices may also be removably worn by proctors 421 and/or examinees 411. For example, and without limiting the scope of the present invention, such proximity devices may be incorporated with the wearable monitoring devices; or in other embodiments, the proximity devices may be standalone, but removably wearable. Such proximity devices may utilize wireless communications, such as WiFi, Bluetooth, NFC (near field communication), and/or other wireless signals associated with for example, RFID communication. By using such proximity devices, moving too far away (which may be predetermined) from the environment 101, proxy server 210, command device 110, interactive devices 150, and the like, may result in triggering various alerts, pausing or stopping a session, scrambling displayed content on one more interactive devices 150, and/or flagging monitoring data 570 for present (at least near real-time by forensics module review of exam data 550) and/or subsequent evaluation, auditing, and/or validation.

The integral pixel counter and/or pixel tracker may be used in interactive devices 150 wherein the interactive device 150 may include a touchscreen for receiving user input (and/or on command devices 110). In some applications of use, the pixel counter and/or pixel tracker may serve a similar purpose as typing trackers (keyboard logs) used with more traditional keyboards. In some applications of use, the pixel counter and/or pixel tracker may be used for signature analysis and other swiping and/or drawing input analysis. The pixel counter and/or pixel tracker may be used for capturing fingerprint scans as well. The media screen capture may be used to take screen shots of the interactive device's 150 GUI. Typing trackers (keyboard logs) may be used in interactive devices 150 wherein the interactive device 150 may include a traditional keyboard for receiving user input. For example, and without limiting the scope of the present invention, by analyzing typing speeds and patterns, and swiping motions of an interactive device user 410 (e.g. examinee 411), may trigger data flagging and/or an alert for present (e.g. present video and audio monitoring by proctor 421 using command device 110) and/or subsequent evaluation, auditing, and/or validation. By using such techniques increased likelihoods of various improprieties may be detected for further evaluation, e.g. such techniques may demonstrate an unauthorized change in examinee 411 using a particular interactive device 150 during the exam session.

Eye tracking and/or facial recognition may use inputs received from one of the cameras, e.g. the front facing camera; along with complimentary software. The complimentary software, which may be commercially available off the shelf software, may analyze the inputs received from one of the cameras to provide eye tracking and/or facial recognition functionality. In various embodiments, the complimentary software may be running on the interactive device 150, the proxy server 210, the server 201, the monitoring devices, and/or the command device 110. With respect to tracking eye movement, the system and/or the method may track eye movement and correlate such results with user (e.g. examinee 411) responses within a particular session. The system and/or the method may use facial recognition to detect that if an examinee 411 (and/or proctor 421) may have changed during a particular exam session. Such a detected change may raise a flag, i.e. trigger an alert, for present and/or subsequent evaluation, auditing, and/or validation.

Auditory tracking and/or auditory analysis may use inputs received from an integral microphone; along with complimentary software. The complimentary software, which may be commercially available off the shelf software, may analyze the inputs received from the integral microphone to auditory tracking, analysis, and/or recognition functionality. In various embodiments, the complimentary software may be running on the interactive device 150, the proxy server 210, the server 201, the monitoring devices, and/or the command device 110. For example, and without limiting the scope of the present invention, such complimentary software by using fast-Fourier analysis (and/or other statistical analysis techniques) the system and/or the method may detect anomalous readings in recorded audio (e.g. stress, whispering, and the like); and may then flag such audio (and linked video) for present and/or subsequent evaluation, auditing, and/or validation.

EEG tracking and/or analysis may use inputs received from an integral EEG sensors; along with complimentary software. The complimentary software, which may be commercially available off the shelf software, may analyze the inputs received from the integral EEG sensors to provide EEG analysis functionality. In various embodiments, the complimentary software may be running on the interactive device 150, the proxy server 210, the server 201, the monitoring device, and/or the command device 110. Such complimentary software may analyze brainwave patterns and correlate such results with user (e.g. examinee 411) responses within a particular session.

Heartrate and/or breath rate tracking and/or analysis may use inputs received from an integral heartrate and/or breath rate sensors; along with complimentary software. The complimentary software, which may be commercially available off the shelf software, may analyze the inputs received from the integral heartrate and/or breath rate sensors to provide heartrate and/or breath rate analysis functionality. In various embodiments, the complimentary software may be running on the interactive device 150, the proxy server 210, the server 201, the monitoring devices, and/or the command device 110. Such complimentary software may analyze heartrate and/or breath rate patterns and correlate such results with the user (e.g. examinee 411) responses within a particular session. Such heartrate and/or breath rate results may also be linked with the EEG results.

In some embodiments, the at least one integral monitoring device may be active in receiving data, such as check-in data 580 and/or monitoring data 570 during exam check-in 630 and/or during the exam session. The at least one integral monitoring devices may be operating passively and otherwise in the background of the interactive device 150 or command device 110, regardless of user 420 (e.g. proctor 421) and/or user 410 (e.g. examinee 411) conduct. Data captured from such integral monitoring devices (and monitoring devices in general) may be done at certain rates per second (e.g. FPS with video) and such capture rates may be predetermined and may be changed to capture more or less data as may be desired.

In some embodiments, client devices 240 may be commercially available and unmodified or un-customized with respect to hardware, wherein what may be custom may be at least some of the software installed on such client devices to configure such client devices 240 to conforming with the system and/or the method.

In some embodiments, the at least one client device 240, including interactive devices 150 and including monitoring devices (including standalone camera 175, wearable monitoring devices, and wearable camera 178), may be mobile, i.e., readily transportable. That is, while some of client devices 240 may be substantially fixed for the duration of the exam session within environment 101, such client devices 240 may be transported from one different environment 101 to another. Wearable monitoring devices may be mobile during the exam session as proctors 421 and/or examinees 411 move around. To aid in such mobility, in some embodiments, the at least one client device 240 may be battery powered for at least the duration of the exam session. Such devices in some embodiments may also receive electrical power from standard wall outlets.

Now turning to a further discussion of command device 110. In some embodiments, e.g., as depicted in FIG. 1, the system and/or the method may comprise at least one command device 110. In some embodiments, at least one command device 110 may be used for one or more of: (1) starting and verifying delivery of at least one predetermined question 511 (from question batch 512) to the at least one proxy server 210 and/or to at least one interactive device 150; (2) facilitating exam check-in of examinees 411; (3) accessing examinee information (e.g. user info 561); (4) tracking time during the exam session; (5) viewing (e.g., in real-time) monitoring data 570 received by at least one monitoring device; (6) viewing various exam data 550 received by at least one interactive device 150; (7) verifying exam data 550 may have been received from at least one client device 240; (8) verifying exam data 550 may have been removed from at least one interactive device 150; (9) starting and verifying delivery of exam data 550 from at least one proxy server 210 to the at least one server 201 or from at least one interactive device 150 to the at least one server 201; (10) performing exam validation (e.g. forensics analysis) of exam data 550; (11) performing grading of exam data 550; (12) providing exam feedback; (13) pausing or stopping the exam session; (14) pausing or stopping particular interactive devices 150; (15) scrambling displayed content on particular interactive devices 150; and the like.

In some embodiments, at least one command device 110 may be in wireless or wired communication with one or more of: at least one server 201 (across network 260), at least one proxy server 210, at least one client device 240, at least one interactive device 150, the at least one monitoring device, at least one computing-device 220; and the like.

In some embodiments, at least one command device 110 may be selected from one or more of the group consisting of: a tablet computing device (tablet), a laptop, a PC, a desktop computer, a smartphone, a smart watch, and the like. In some embodiments, command device 110 may be a computing device. In some exemplary embodiments, the command device 110 may not have access and/or may not display exam questions 511, nor answers 555 to exam questions 511. This may be so to mitigate against proctor 421 improprieties and biases.

In some embodiments, at least one command device 110 may comprise at least one integral monitoring device for facilitating exam check-in 630 and/or for facilitating proctor monitoring during the exam session.

In some embodiments, the at least one integral monitoring device may be selected from one or more of the group comprising: at least one front facing camera, at least one rear facing camera, at least one integral microphone, at least one gyroscope and/or accelerometer, at least one GPS circuit, pixel counter, pixel tracker, media screen capture, typing tracking, eye tracking, facial recognition, auditory recognition, EEG sensor, heartrate sensor, breath rate sensor, proximity devices, at least one means for reading at least one fingerprint, and the like.

In some embodiments, the at least one integral monitoring device (integral with command device 110) may be active in receiving data during exam check-in 630 and/or during the exam session. The at least one integral monitoring devices may be operating passively and otherwise in the background of command device 110, regardless of user 420 (e.g. proctor 421) conduct. Data captured from such integral monitoring devices (and monitoring devices in general) may be done at certain rates per second (e.g. FPS with video) and such capture rates may be predetermined and may be changed to capture more or less data as may be desired.

In some embodiments, at least one command device 110 may be mobile, i.e., readily transportable and battery operated for at least a duration of the exam session. Command devices 110 in some embodiments may also receive electrical power from standard wall outlets.

In some embodiments, command devices 110 (and interactive devices 150) may be configured to connect to one or more cameras (and/or other monitoring devices) via a data transmission cable, such as a USB cable (including micro USB). Those cameras could be standalone cameras 175 or wearable cameras 178. For example, in FIG. 1, integral camera 177 may not be integral in some embodiments but instead may be a standalone camera connected to command device 110 via a data transmission cable. While FIG. 1 may depict such a deployment configuration using command device 110, standalone cameras could be connected to interactive devices 150 also using a data transmission cable. Use of such standalone cameras with wired connections to command devices 110 and/or to interactive devices 150 may enable additional, directional cameras to be utilized.

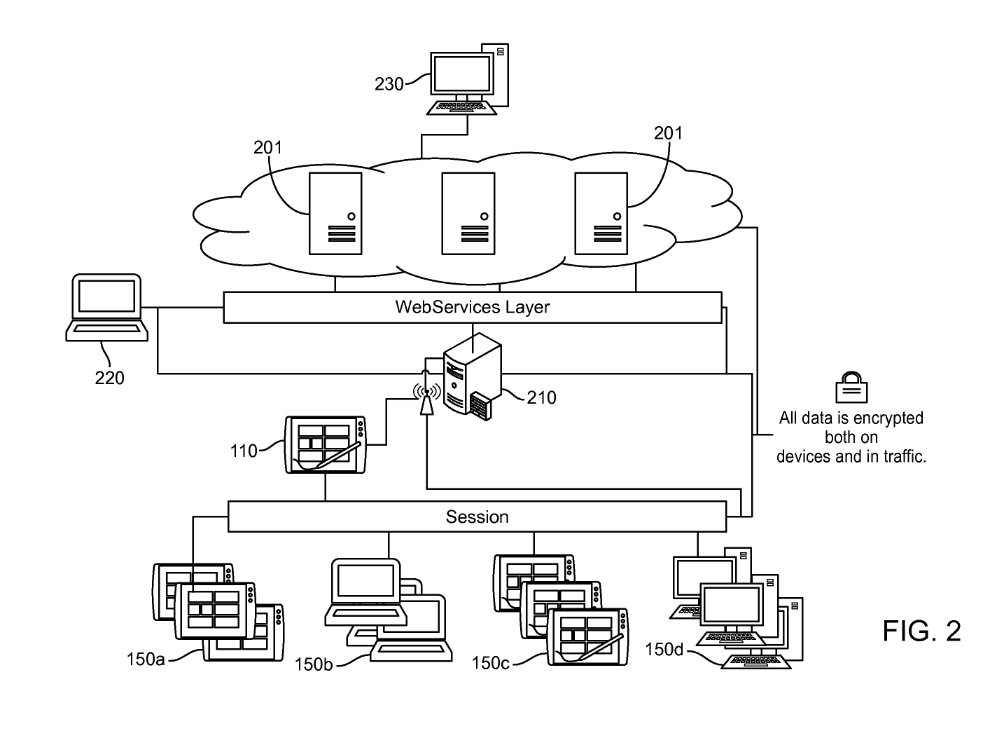

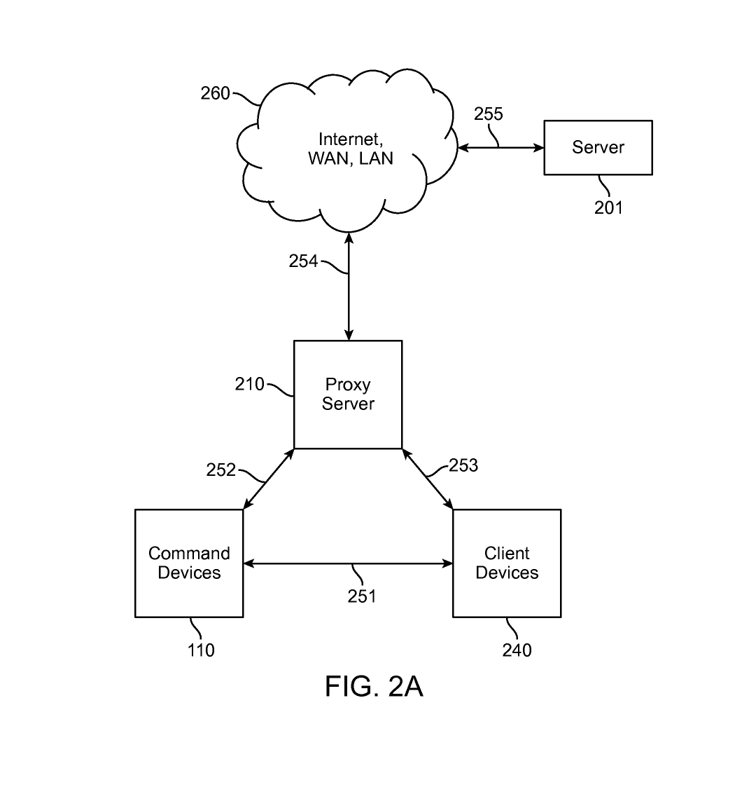

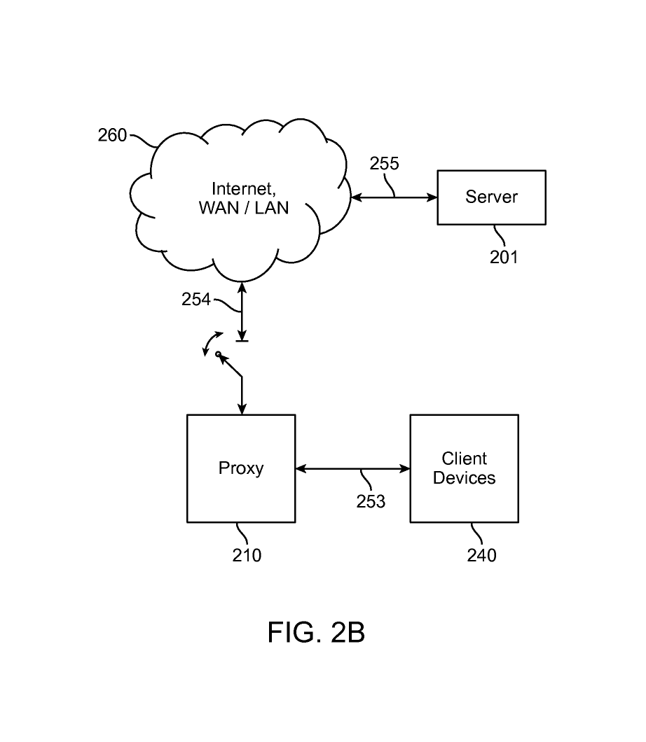

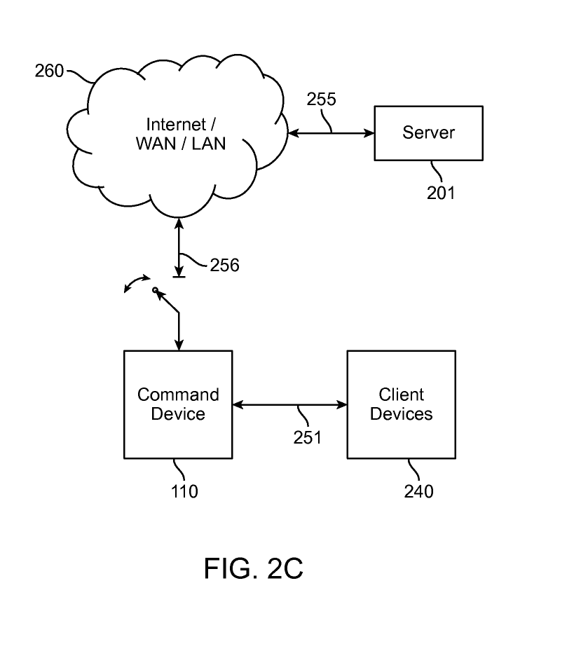

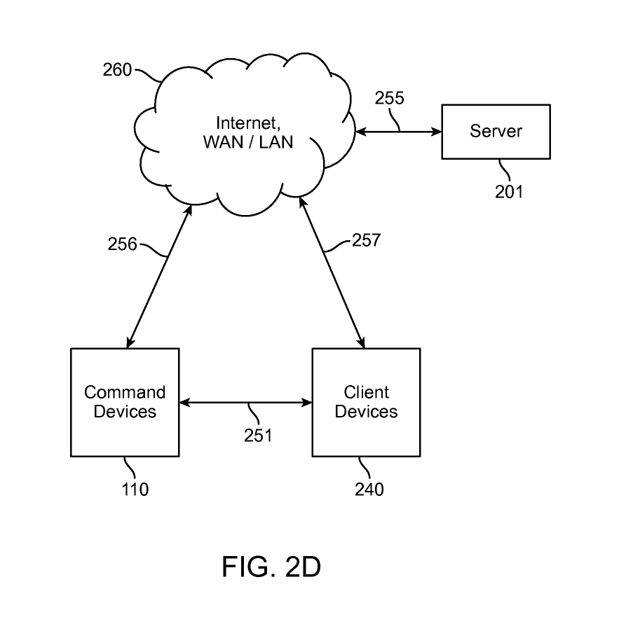

FIG. 2 may depict a block diagram of servers 201, at least one proxy server 210, and various devices (server access station 230, computing-device 220, command device 110, and a variety of interactive devices 150) all depicted with various communication relationships, wherein various web-based services 601 and/or various deployed configurations of the various devices may be used for mobile, reliable, and/or secure testing, voting, and/or learning.

For example, and without limiting the scope of the present invention, the configuration depicted in FIG. 2 may be exemplary for high stakes examination (testing). High stakes may refer to examinations (or voting) wherein security may be at its highest or there may be a need for high security. Such security may refer to protecting exam questions 511 from inadvertent disclosure, protecting answers 555 from inadvertent disclosure, protecting user info 561 from inadvertent disclosure, minimizing examinee 411 cheating and/or other examinee 411 improprieties, and/or minimizing proctor 421 conflict of interest (bias) and/or other proctor 421 improprieties.

Such high stakes examination may be associated with professional and vocational (trade) licensing and/or registering exams. For example, such professional and vocational licensing/registering exams may include, but may not be limited to: various heavy machinery operator exams (e.g. crane operators), state board exams (e.g. for various medical practitioners), real estate practitioner exams, state bar exams, professional engineering exams, and the like.

Such high security may be achieved by the system and/or the method utilizing various hardware components, software, and/or physical procedural protections. For example, in such high stakes embodiments, at least one proxy server 210 may be used. All or some subset of data 501 (e.g. exam data 550) may be non-transitorily stored within proxy computer readable media, and stored in an encrypted format—until such data may be delivered back to server 201. In some embodiments, at least one proxy server 210 may also comprise one or more anti-tampering devices/software.

Note, the various monitoring devices, including wearable monitoring devices, standalone monitoring devices, integral monitoring devices, as discussed above, may also be utilized in high stakes embodiments; note however, that such monitoring devices may not be depicted in FIG. 2, but may be addressed in FIG. 2A, wherein client devices 240 may comprise both interactive devices 150 and the various monitoring devices.

In FIG. 2, server access station 230 may be used by system admin 450 to access at least one server 201. In some embodiments, server access station 230 and at least one server 201 may be in a LAN with each other. In other embodiments, server access station 230 may access at least one server 201 across network 260, like computing-device 220. In some embodiments, server access station 230 may comprise a tablet computing device (tablet), a laptop, a PC, a desktop computer, a different server, a smartphone, a smart watch, and the like.

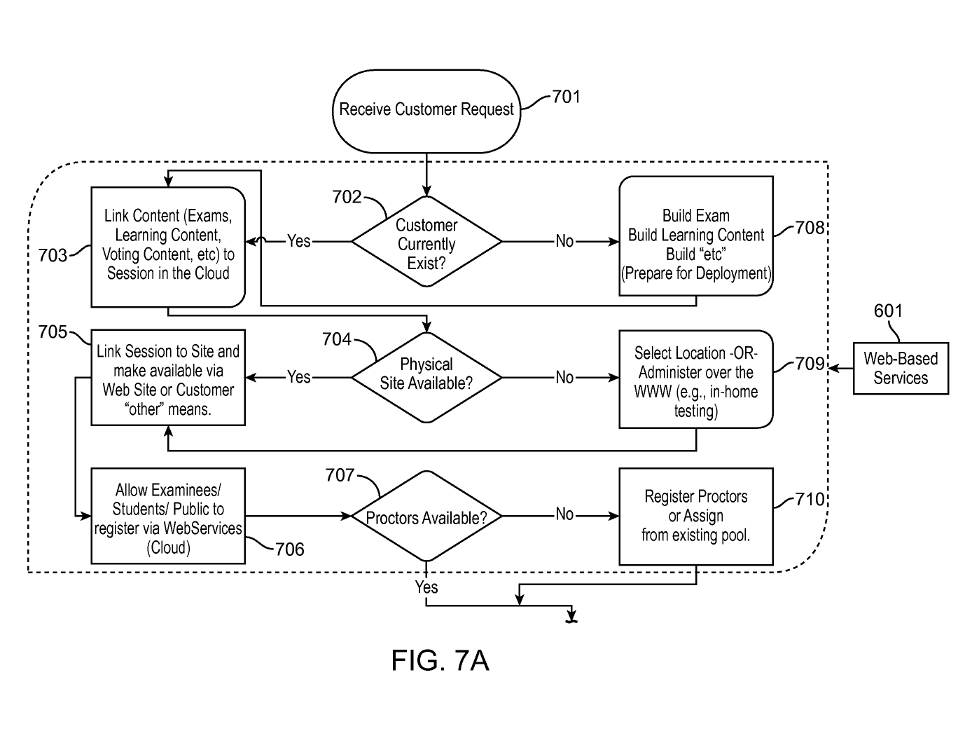

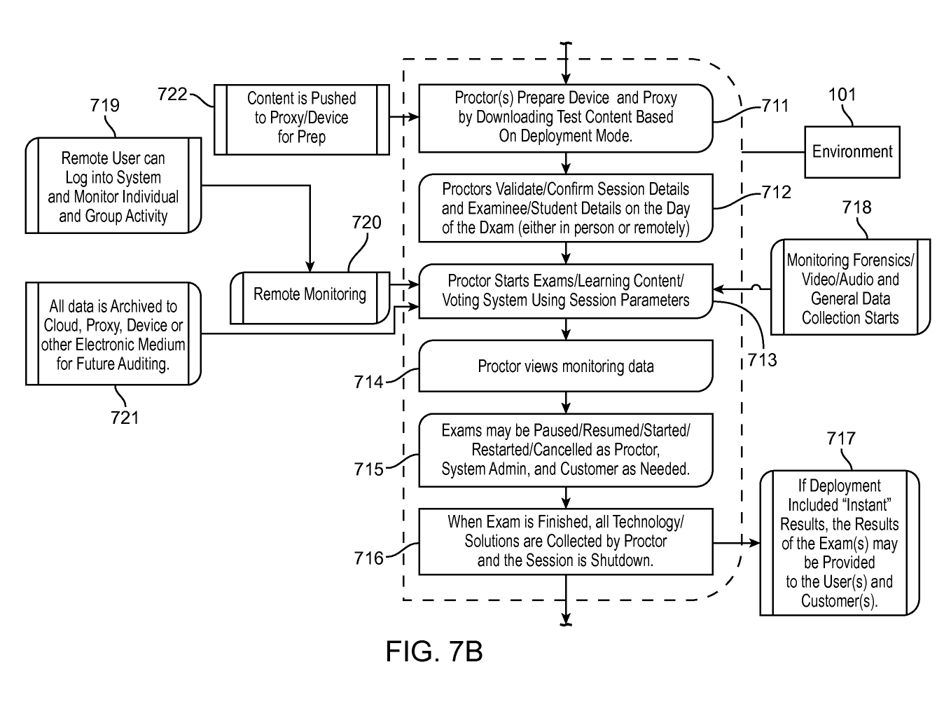

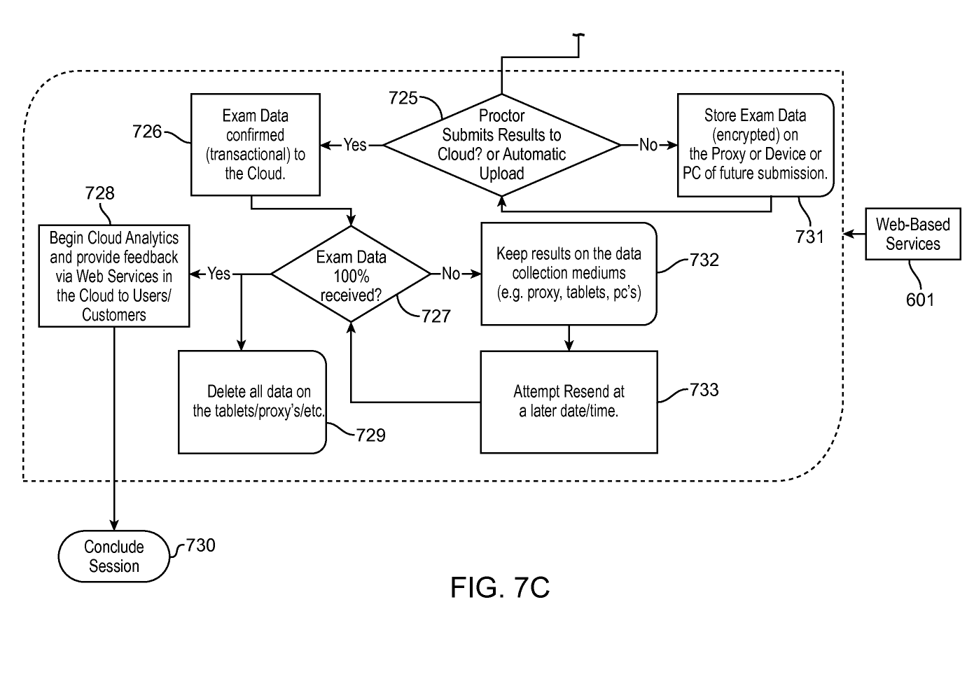

In FIG. 2, computing-device 220 may be used by users 401 to access various web-based services 601 (denoted as “WebServices Layer” in FIG. 2) provided by at least one server 201. In some embodiments, computing-device 220 may be used for various remote viewing (monitoring) activities in near real-time of a session (e.g. an exam session) (see e.g., FIG. 7B). In some embodiments, computing-device 220 may access at least one server 201 across network 260. In some embodiments, computing-device 220 may comprise a tablet computing device (tablet), a laptop, a PC, a desktop computer, a different server, a smartphone, a smart watch, and the like.

Note, with respect to scalability, as a quantity of examinees 411, interactive devices 150 used by examinees 411, and/or monitoring devices increases, additional proxy servers 210 and/or command devices 110 may be deployed, much in the same manner a server farm may be expanded to accommodate increased processing demands. And because connection to network 260 may only be necessary at two points in the process, i.e. at download of question batch 512 prior to the exam session and when uploading exam data 550 at the end of the exam session, bandwidth constraints in communication across network 260 may not affect the system and/or the method performance nor scalability during exam check-in 630 and/or during the duration of the exam session, when the system and/or method may be operating in offline mode with respect to network 260.

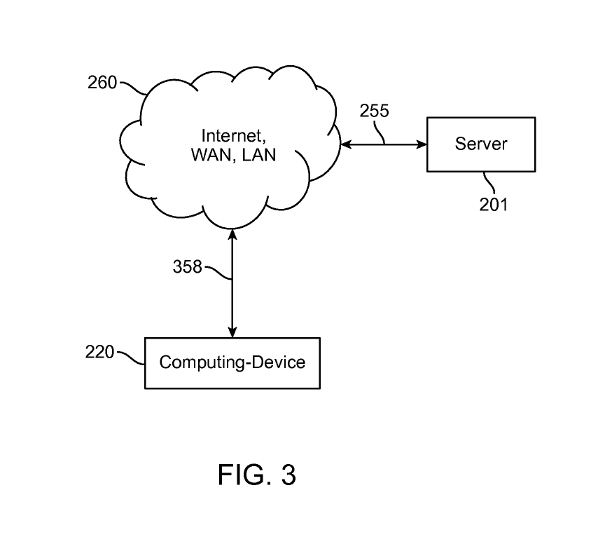

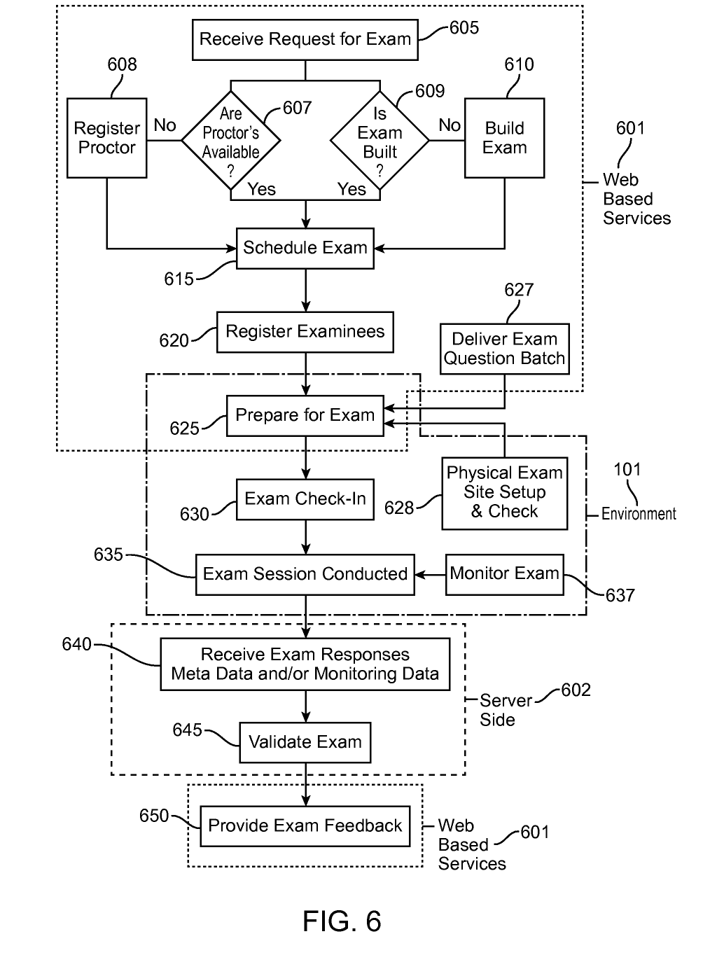

Now turning to a discussion of FIG. 2A. FIG. 2A may depict a block diagram of at least one server 201, at least one proxy server 210, at least one command device 110, and at least two client devices 240 (at least one interactive device 150 and at least one monitoring device), all depicted with various communication relationships, such that mobile, reliable, and/or secure testing, voting, and/or learning may be carried out. Note, FIG. 2A may also be an exemplary high stakes embodiment and may be similar to FIG. 2 in configuration, with the exception that in FIG. 2A, the web-based services 601, server access station 230, and computing-device 220 functionality has been removed from FIG. 2A depiction, but such functionality may still be present in the depicted embodiment, it may just not be a focus of FIG. 2A. Web-based services 601 and computing-device 220 functionality may be further discussed in the FIG. 3 discussion and in the FIG. 6 discussion.

Continuing discussing FIG. 2A, in some embodiments, the system and/or the method for conducting a reliable, secure, and/or mobile exam may comprise at least one server 201. In some embodiments, at least one server 201 may comprise: server computer readable media (memory), a server processor, a server network card, and the like. Such server components may be generally available in commercially off the shelf servers. The server computer readable media may non-transitorily stores data (e.g. data 501) and executable code. The executable code may comprise various application specific software programs, including more general operating systems (e.g. LINUX, WINDOWS, MAC, and the like). The server processor may be controlled by the executable code. The server processor may be in electrical or optical communication with the server computer readable media. The server network card may be for controlling external communications with the at least one server 201. The server network card may be in electrical or optical communication with the server processor.

In some embodiments, data 501 may comprise at least one predetermined question 511. In some embodiments, the executable code may permit at least one server 201 to deliver (transmit) at least one predetermined question 511 to at least one interactive device 150 across network 260 for use in a scheduled examination. In some embodiments, communication between at least one server 201 and network 260 may be controlled by the server network card. In some embodiments, network 260 may be selected from one or more of the group comprising: the internet, a wide area network (WAN), a local area network (LAN), and the like.

In some embodiments, the executable code may permit at least one server 201 to receive at least one answer 555 in response to the at least one predetermined question 511 from the at least one interactive device 150. In some embodiments, e.g., high stakes embodiments, at least one proxy server 210 may be used as an intermediary device between interactive devices 150 (and monitoring devices) and at least one server 201.

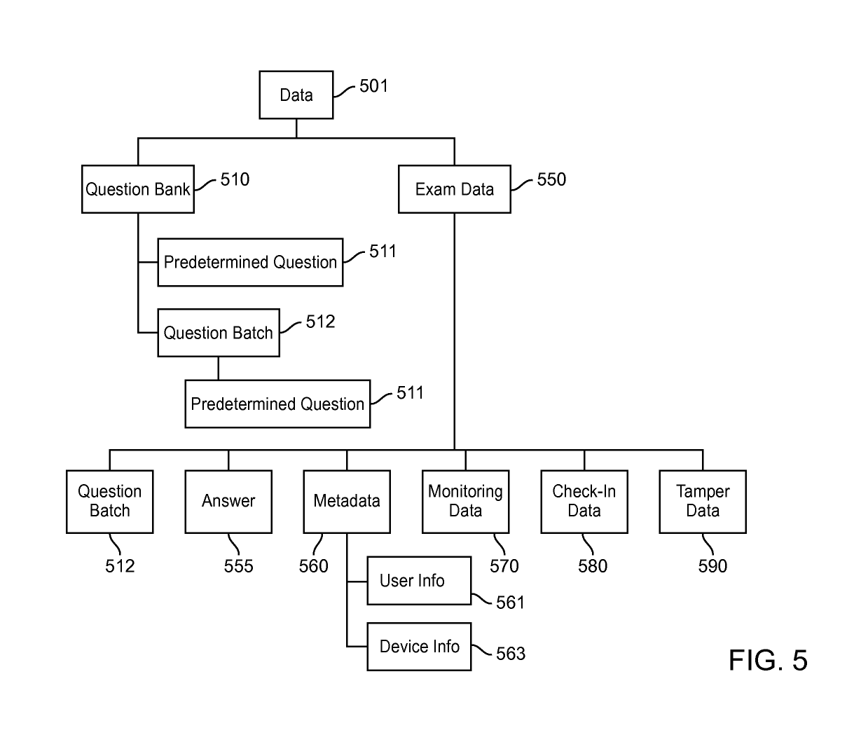

In some embodiments, data 501 may be selected from one or more of the group comprising: at least one predetermined question 511, at least one answer 555 in response to the at least one predetermined question 511, at least one question bank 510, at least one question batch 512, exam data 550, metadata 560, monitoring data 570, and the like. Data 501 structure and relationships may be further discussed below in the FIG. 5 discussion.

In some embodiments, predetermined questions 511 delivered from at least one server 201 to at least one proxy server 210 or to at least one interactive device 150 may be predetermined. That is, predetermined questions 511 may predetermined in a sense of that the question was previously written and vetted; e.g., by system admin 450, by third party 431, and/or interested party 435. In some embodiments, predetermined questions 511 may predetermined in a sense that questions to be used for a particular exam session may be determined prior to the exam session being held.

For example, and without limiting the scope of the present invention, in some embodiments, the at least one server 201 may receive a selection for a particular question batch 512 to be administered for the particular exam session. In some embodiments, the particular question batch 512 may comprise a finite plurality of predetermined questions 511 selected from a question bank 510.

For example, and without limiting the scope of the present invention, a question bank 510 for a particular subject matter may comprise 1,000 unique predetermined questions 511 and the question batch 512 may comprise 100 predetermined questions 511 selected from that 1,000 question bank 510. Such a determination of which predetermined questions 511 may comprise a given question batch 512 may be done by system admin 450, by third party 431, and/or interested party 435, depending upon the embodiment. This selected question batch 512 may then be delivered to the least one interactive device 150 in at least two formats: delivery of the entire question batch 512 such that the entire question batch 512 may reside upon the at least one interactive device 150 (a low stakes embodiment); or delivery of one predetermined question 511 at a time from the question batch 512 to at least one interactive device 150.

In either format, predetermined questions 511 delivered to the at least one interactive device 150 may be randomized, such that any two or more interactive devices 150 receiving predetermined questions 511 may receive predetermined questions 511 in a randomized order. That is, randomization may be conducted by the at least one server 201 or the at least one proxy server 210, via the executable code or the proxy executable code, respectively. Randomization may be done for each interactive device 150 to receive predetermined questions 150.

Alternatively or in addition to randomizing, the executable code or the proxy executable code may check randomized output of predetermined question 511 order to check if any physically adjacent interactive device 150 might receive a single predetermined question 150 in the same order (or at the same time) and if found, may re-randomize at least one of the orders prior to predetermined question 511 delivery to one of those physically adjacent interactive devices 150.

Physically adjacent interactive devices 150 may be noted and logged prior to beginning an examination session, during exam check-in, by proctor 421 physically entering notations in at least one command device 110.

Or alternatively, the system and/or method may automatically determine physically adjacent interactive devices 150 by using monitoring data 570 from at least one monitoring device (e.g. an IR depth and 3D mapping camera), using check-in data 580 from at least one interactive device 150, and/or by using integral monitoring devices which may be present in the interactive devices 150 (e.g. GPS circuits, RFIDs, Bluetooth, NFC, and the like).

In some exemplary embodiments (e.g. high stakes), at least one predetermined question 511 may be delivered to at least one interactive device 150 in an encrypted format.

In some exemplary embodiments (e.g. high stakes), the system and/or the method may comprise at least one proxy server 210. In some embodiments, at least one proxy server 210 may comprise: proxy computer readable media (proxy memory), a proxy server processor, a proxy server network card, and the like. Such proxy server components may be generally available in commercially off the shelf proxy servers. That is, proxy server 210 may be a server that may be configured for mobility and battery operation; and in some embodiments may comprise anti-tampering means. The proxy computer readable media may non-transitorily store some subset of data 501 (e.g. data 550) and proxy executable code. The proxy executable code may comprise various application specific software programs, including more general operating systems (e.g. LINUX, WINDOWS, MAC, and the like). The proxy server processor may be controlled by the proxy executable code. The proxy server processor may be in electrical or optical communication with the proxy computer readable media. The proxy server network card may be for controlling external communications with the at least one proxy server 210. The proxy server network card may be in electrical or optical communication with the proxy server processor.

In some embodiments, at least one proxy server 210 may be in communication with at least one server 201 for sufficient time to receive at least one predetermined question 511 prior to administration of the exam session. In some embodiments, at least one proxy server 210 may be in communication with least one interactive device 150 during some time of the exam session. In some exemplary embodiments, at least one proxy server 210 may be in communication with least one interactive device 150 during an entirety of the exam session. In some embodiments, at least one proxy server 210 may deliver (transmit) to at least one interactive device 150 at least one predetermined question 511.

In some embodiments, at least one proxy server 210 may receive from at least one interactive device 150 at least one response 555 (e.g. answer 555) to at least one predetermined question 511. In some embodiments, at least one proxy server 210 may be in communication with the at least one server 201 for sufficient time to deliver (transmit) at least one answer 555 post administration of the exam session to at least one server 201. As noted above, delivery of predetermined questions 511 to interactive devices 150 may be done so wherein the delivery of question order may be randomized; likewise a plurality of answers 555 received from interactive devices 150 (e.g. to proxy server 210 and then later to server 201) may also be received in a randomized order. Each delivered predetermined question 511 may be paired with a specific answer 555, paired in a keyed pairing, such that randomization of answers 555 does not destroy the keyed pairing and at server 201 the appropriate answer 555 may then be paired with the appropriate predetermined question 511.

In some embodiments, the some subset of data 501 (e.g., exam data 550) that may be non-transitorily stored in the proxy computer readable media may be stored in an encrypted format. For example, and without limiting the scope of the present invention, in some embodiments, any or some data delivered to at least one interactive device 150 from the at least one proxy server 210, including the at least one predetermined question 511, may be delivered in an encrypted format. For example, and without limiting the scope of the present invention, in some embodiments, any or some data delivered to at least one server 201 from the at least one proxy server 210, including the at least one answer 555, may be delivered in an encrypted format.

In some embodiments, at least one proxy server 210 may be mobile, i.e. readily transportable. In some embodiments, at least one proxy server 210 may be powered by a battery for at least an entirety of the exam session. In some embodiments, at least one proxy server 210 may receive electrical power from standard removable wired connections to an outlet. In some embodiments, at least one proxy server 210 may receive electrical power from a battery backup in the event power from the outlet fails for some reason. Such mobility and battery operation may permit 210 to be transported to one or more environments 101, wherein question batch 512 may be downloaded from server 201, and then proxy server 210 may deliver predetermined questions 511 to interactive devices 150 and may receive answers 555 from interactive devices 150, and then proxy server 210 may then upload exam data 555 to server 201. Thus, proxy server 210 may only need an internet connection or connection with network 260 during question batch 512 download and then subsequently when uploading exam data 555 to server 201. But during the exam session proxy server 210 may not need any internet connection or connection to network 260. Thus communication pathway 254 in FIG. 2A may be open or closed as necessary. Keeping communication pathway 254 closed and/or broken may be preferable during the exam session, as this may minimize unauthorized access to proxy server 210 by some entity using network 260, i.e. by hacking into proxy server 210.

When communication pathway 254 may be closed, proxy server 210, command device 110, and/or client devices 240 may be operating in an “offline” mode during the session (e.g. exam session) with respect to connecting to network 260 or the internet. In some exemplary high stakes embodiments, exam data 550 generated while in the offline mode, may be encrypted and preferably stored non-transitorily on proxy server 210—until the session concludes and all verified received exam data 550 may then be delivered (transmitted) to server 201 via now open communication pathway 254.

In some embodiments (e.g. some high stakes), when communication pathway 254 may be closed during the session, communication pathways 251, 252, and 253 may all still be open and in operation (either wirelessly, wired, or a combination), such that proxy server 210, client devices 240 (including interactive devices 150 and monitoring devices), and/or command device 110 may all form a LAN at or within environment 101.

In some embodiments, at least one server 201 may receive a selection for a particular question batch 512 to be administered for a particular exam session. The particular question batch 512 may comprise a finite plurality of predetermined questions 511 selected from a question bank 510. The executable code may cause at least one server 201 to deliver to at least one proxy server 210 the particular question batch 512. At least one proxy server 210 may then deliver to each interactive device 150, from a plurality of interactive devices 150, the question batch 512, such that each interactive device 150 may receive the question batch 512 with the finite plurality of predetermined questions 511 in a randomized order, such that an order in which an examinee 411 may read, see, and/or hear any individual predetermined question 511 may be random.

In some embodiments, at least one server 201 may receive a selection for a particular question batch 512 to be administered for a particular exam session. The particular question batch 512 may comprise a finite plurality of predetermined questions 511 selected from a question bank 510. The executable code may cause at least one server 201 to deliver to at least one proxy server 210 the entire particular question batch 512. At least one proxy server 210 may deliver to each interactive device 150, from a plurality of interactive devices 150, one predetermined question 511 at a time, selected at random, from question batch 512, such that each interactive device 150 may receive one predetermined question 511 at a time delivered in a randomized order, such that an order in which an examinee 411 may read, see, and/or hear any individual predetermined question 511 may be random. Randomized question delivery to examinees 411 makes it difficult for adjacent examinee 411 to cheat off of each other.

In some embodiments, at least one proxy server 210 may receive a request from one of the interactive devices 150 for delivery of one predetermined question 511, the proxy executable code may cause retrieval of any presently residing predetermined question 511 from the interactive device 150 before delivering a next predetermined question 150, such that at any given time during the exam session, only one predetermined question 150 may reside on the interactive device 150.

In some embodiments, at least one proxy server 210 may be configured by use of the proxy network card to receive at least some data, including the at least one predetermined question 511, from the at least one server 201. In some embodiments, at least one proxy server 210 may be configured by use of the proxy network card to deliver at least some data, including the at least one answer 555, to least one server 201. Such communication may be across network 260, i.e. when there may be network 260 between at least one proxy server 210 and at least one server 201.

In some embodiments, at least one proxy server 210 may be configured by use of the proxy network card to receive at least some data, including the at least one answer 555, from at least one client device 240, including the least one interactive device 150. In some embodiments, at least one proxy server 210 may be configured by use of the proxy network card to deliver at least some data, including the at least one predetermined question 511, to at least one client device 240, including the at least one interactive device 150.

In some embodiments, at least one proxy server 210 may comprise at least one tampering detector for detecting unscheduled proxy server 210 movement and/for detecting unscheduled access or attempted access to encrypted data non-transitorily stored within the proxy computer readable media. In some embodiments, the tampering detector may comprise a gyroscope and/or an accelerometer and/or a GPS circuit.

In the exemplary embodiment depicted in FIG. 2A, the system and/or the method may comprise at least one client device 240. Client device 240 may comprise both interactive devices 150 and monitoring devices. In some embodiments, at least one client device 240 may comprise a client network communications means. The client network communications means may permit wireless or wired communication with at least one proxy server 210, at least one server 201, at least one command device 110, with other client devices (such as interactive devices 150), at least one router, and the like.

In some embodiments, wireless communications between client devices 240, from client devices 240, and/or to client devices 240 may be by WiFi protocols, Bluetooth, NFC, RFID, and any other wireless communication suitable for these intended purposes. In some embodiments, wireless communications between: (1) client devices 240 and command devices 110 denoted by communication pathway 251; (2) client devices 240, command devices 110, and proxy server 210; (3) command devices 110 and proxy server 210 denoted by communication pathway 252; and (4) client devices 240 and proxy server 210 denoted by communication pathway 253 may be by WiFi protocols, Bluetooth, NFC, and/or any other wireless communication suitable for these intended purposes. Client devices 240; client devices 240 and command devices 110; and/or client devices 240, command devices 110, and/or proxy server 210 may form one or more LANs. Such LANs may be deployed at one or more environments 101 (which may be either geographically separate and/or temporally distinct). In some embodiments, proxy server 210 may be within or in a predetermined proximity of environment 101. Such LANs may be temporary, being in creation for exam check-in, the exam session, and in concluding the exam session.

Proxy server 210 may be in communication with server 201 across network 260 via communication pathway 254 which may link proxy server 210 and network 260 and via communication pathway 255 which may link server 201 to network 260. See e.g., FIG. 2A.

In some embodiments, in FIG. 2A, communication pathways 251, 252, 253, 254, and 255 may all be encrypted and/or secure communications. In some embodiments, data being communicated via communication pathways 251, 252, 253, 254, and/or 255 may be independently encrypted regardless if the communication pathway may be encrypted and/or secure. In some embodiments, in FIG. 2A, communication pathways 251, 252, 253, 254, and 255 may be wireless and/or wired communications. In exemplary embodiments, communication pathways 251, 252, 253, and 254 may be wireless. Such wireless communications may be by WiFi protocols, Bluetooth, NFC, and/or any other wireless communication suitable for these intended purposes.

In some embodiments, some or any data (e.g. exam data 550) generated, received, recorded, delivered (transmitted) and/or captured by at least one client device 240 may be encrypted. In various embodiments, some or any data generated, received, recorded, and/or captured by the at least one client device 240 may be delivered (transmitted) with such data encrypted to be received by at least one proxy server 210, at least one server 201, and/or at least one command device 110. In some embodiments, some or any data received from at least one client device 240 by the at least one proxy server 210 or the at least one server 201, and/or at least one command device 110 may be received with the data encrypted. Note, the higher the exam stakes may be, there may be less reliance of non-transitorily storing encrypted data or non-encrypted data on command device 110; whereas, instead, at least one proxy server 210 may be used to non-transitorily store such encrypted data.

FIG. 2B may depict a block diagram of at least one server 201, at least one proxy server 210, and at least one client device 240, all depicted with various communication relationships, such that mobile and reliable testing, voting, and/or learning may be carried out. The embodiment depicted in FIG. 2B may differ from FIG. 2A in that command device 110 may not be utilized. However, because proxy server 210 may still be utilized, the embodiment depicted in FIG. 2B may still accommodate some high stakes exams. Embodiments of FIG. 2B may be used when proctor 421 may carry out at least some of the functions associated with command device 110 manually and/or with via various paper and handheld writing implements. For example, and without limiting the scope of the present invention, exams conducted in secondary schools and universities might be accomplished utilizing a deployment associated with FIG. 2B. Of course, when the command device 110 of FIG. 2A may be added, additional functionality may be gained.

Note, in FIG. 2B a break in communication pathway 254 between proxy server 210 and network 260 may indicate that proxy server 210 may not always be in communication with network 260. Proxy server 210 may only need an internet connection or connection with network 260 during question batch 512 download and then subsequently when uploading exam data 555 to server 201. But during the exam session proxy server 210 may not need any internet connection or connection to network 260. Thus communication pathway 254 in FIG. 2B (and in FIG. 2A) may be open or closed as necessary. Keeping communication pathway 254 closed and/or broken may be preferable during the exam session, as this may minimize unauthorized access to proxy server 210 by some entity using network 260, e.g. by hacking into proxy server 210.

FIG. 2C may depict a block diagram of at least one server 201, at least one command device 110, and at least one client device 240, all depicted with various communication relationships, such that mobile and reliable testing, voting, and/or learning may be carried out. The embodiment depicted in FIG. 2C may differ from FIG. 2A in that proxy server 210 may not be utilized in FIG. 2C. Instead command device 110 may take over some of the functionality of proxy server 210, such as non-transitory storage of exam data 550 on memory of command device 110. Because exam data 550 may be stored on command device 110, which may increase tampering risks, this embodiment may be lower stake than the higher stakes embodiments depicted in FIG. 2, FIG. 2A, and FIG. 2B. Additionally, because command device 110 may have less processing power than proxy server 210 and/or less memory, the embodiment depicted in FIG. 2C may be operationally slower than the embodiments depicted in FIG. 2, FIG. 2A, and FIG. 2B. And because command device 110 may have less processing power than proxy server 210 and/or less memory, the embodiment depicted in FIG. 2C may accommodate fewer examinees 411 utilizing interactive devices 150 and/or fewer monitoring devices as compared to the embodiments depicted in FIG. 2, FIG. 2A, and FIG. 2B. However, my using more than one command device 110, some of these performance issues (e.g. slower performance and less memory) may be mitigated.

Note, in FIG. 2C a break in communication pathway 256 between command device 110 and network 260 may indicate that command device 110 may not always be in communication with network 260. Command device 110 may only need an internet connection or connection with network 260 during question batch 512 download and then subsequently when uploading exam data 555 to server 201. But during the exam session command device 110 may not need any internet connection or connection to network 260. Thus communication pathway 256 in FIG. 2C may be open or closed as necessary. Keeping communication pathway 256 closed and/or broken may be preferable during the exam session, as this may minimize unauthorized access to command device 110 by some entity using network 260, e.g. by hacking into command device 110.

FIG. 2D may depict a block diagram of at least one server 201, at least one command device 110, and at least one client device 240, all depicted with various communication relationships, such that mobile and reliable testing, voting, and/or learning may be carried out. The embodiment depicted in FIG. 2D may differ from FIG. 2A in that proxy server 210 may not be utilized in FIG. 2D. Instead command device 110 may take over some of the functionality of proxy server 210. And FIG. 2D may differ from FIG. 2C in that client devices 240 may be in communication with server 201, without first routing data through command device 110 as was the situation in FIG. 2C. Here in FIG. 2D, server 201 may non-transitory store exam data 550 as exam data 550 may be received from client devices 240. Thus, embodiments of FIG. 2D may be higher stake than embodiments of FIG. 2C. But because server 201 may be storing exam data 550 as exam data may be received from client devices 240 during the exam sessions (as opposed to storage on proxy server 210 or command device 110), client devices 240 may require communication pathway 257 to be active, open, and viable for the duration of the exam session, such that server 201 may be reached. Thus embodiments of FIG. 2D may be limited to where communication pathway 257 between client devices 240 and network 260 may have a reasonably high likelihood of being maintained, which may exclude embodiments of FIG. 2D from use in some actively moving (e.g. aircraft in flight), rural, subterranean, and/or outdoor environments 101.

With respect to predetermined question 511 delivery by server 201 in FIG. 2D, in some embodiments, the executable code may cause at least one server 201 to deliver to each interactive device 150, from a plurality of interactive devices 150, the question batch 512, such that each interactive device 150 may receive the entire question batch 150 with the finite plurality of predetermined questions 511 in a randomized order, such that an order in which an examinee 411 may read, see, and/or hear any individual predetermined question 511 may be random.

With respect to predetermined question 511 delivery by server 201 in FIG. 2D, in some embodiments, the executable code may cause the at least one server 201 to deliver to each interactive device 150, from a plurality of interactive devices 150, one predetermined question 511 at a time, selected at random, from the question batch 512, such that each interactive device 150 may receive one predetermined question 511 at a time delivered in a randomized order for each interactive device 150, such that an order in which an examinee 411 may read, see, and/or hear any individual predetermined question 511 may be random. In some embodiments, when the at least one server 201 may receive a request from one of the interactive devices 150 for delivery of one predetermined question 511, the executable code may first retrieve any presently residing predetermined question 511 from the interactive device 150 before delivering a next predetermined question 150, such that at any given time during the exam session, only one predetermined question 511 may reside on any interactive device 150 associated (checked-in) with that exam session.

FIG. 3 may depict a block diagram of at least one server 201 in communication with at least one computing-device 220, such that various web-based services may be carried out. In some embodiments, the executable code may permit server 201 to provide at least one web-based service to at least one computing-device in communication with at least one server 201 across the network 260. That is, computing-device 220 may connect and communicate to at least one server 201 via network 260, using communication pathway 358 connecting the at least one computing-device 220 to network 260, and via communication pathway 255 which may connect at least one server 201 to network 260. In some embodiments, at least one computing-device 220 may be selected from one or more of the group comprising: a tablet computing device (tablet), a laptop, a PC, a desktop computer, a different server, a smartphone, a smart watch, and the like.

In some embodiments, the system and/or the method may comprise at least one computing-device 220; whereas, in other embodiments, at least one computing-device 220 may not be a component of the system and/or the method, but at least one computing-device 220 may still be able to access various web-based services 601 provided by at least one server 201.

In some embodiments, at least one web-based service 601 may be selected from one or more of the group comprising: registering users 401 of the system, building an exam 610, requesting an exam 605, scheduling an exam 615, validating an exam session 645, grading an exam session (grading functions), viewing provided exam feedback 650 (e.g. grades and/or exam statistics), and the like.

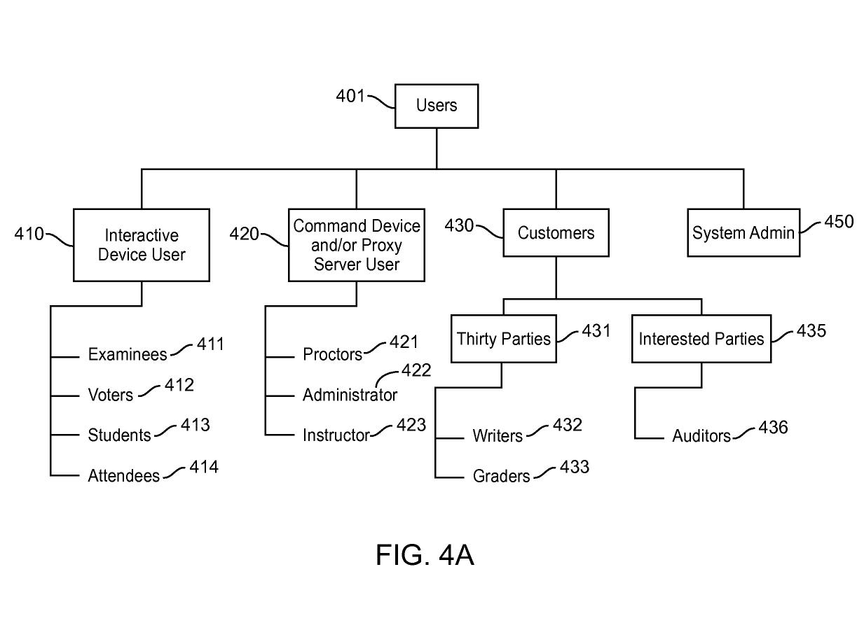

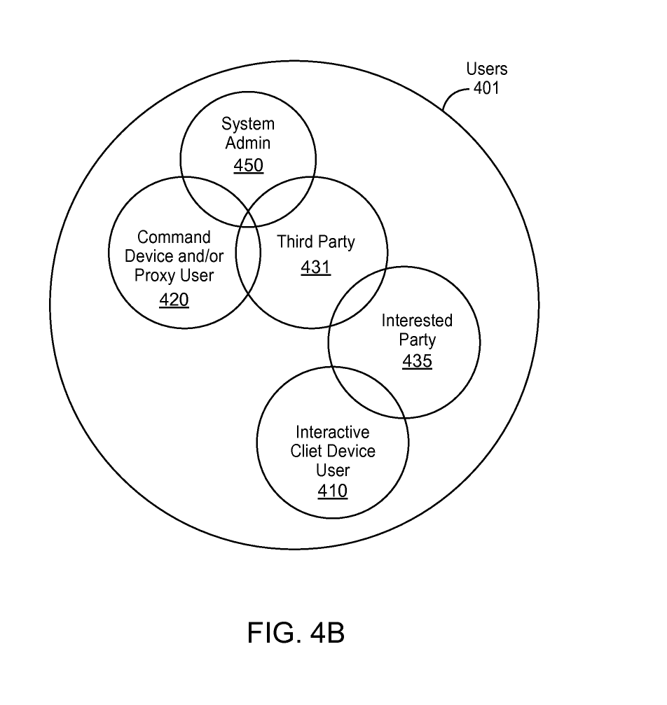

As discussed further under the FIG. 4 discussion, in some embodiments, users 401 of the system and/or the method may be selected from one or more of the group consisting of: interactive client device users 410, command device and/or proxy server users 420, customers 430, third parties 431, interested parties 435, system admins 450, and the like.

In some embodiments, the executable code may permit at least one server 201 to validate 645 a particular exam session from data (e.g. exam data 550) received associated with that particular exam session. See e.g., FIG. 6 discussion below.

In some embodiments, the executable code may permit at least one server 201 to grade the particular exam session from data (e.g. exam data 550) received associated with that particular exam session. Depending upon a type of exam questions administered, some grading may be carried out by the executable code operating on at least one server 201 automatically (or by proxy server 210 or command device 110 in other embodiments where grading and disbursement of grades may be done at the end of the exam session).

For example, and without limiting the scope of the present invention, when administered exam questions 511 may comprise answers known prior to administration, an answer key may be associated with such predetermined questions 511. In some embodiments, writers 432 may construct such answer keys. The executable code operating on at least one server 201 may use such an answer key to automatically grade answers 555. (Or the proxy executable code operating on at least one proxy server 210 may use such an answer key to automatically grade answers 555.)

Predetermined questions 511 types which may be amenable to association with the answer key may be multiple choice questions, true/false questions, matching questions, fill in the blank, some short answer questions, and the like.

Longer short answer questions and essay questions may not be amenable to associating with the answer key, but instead may require full to semi-manual grading using an associated grading rubric by graders 433. Graders 433 may use computing-device 220 to access grading functions, wherein grading functions may be one example of a web-based service provided by at least one server 201. In order to minimize grader 433 conflict of interest (e.g. bias), in exemplary embodiments, grading which may require graders 433 may be done without the grader 433 having access to examinee 411 personal information (e.g. user info 561), such as the examinees 411 name, phone number, email address, address, date of birth, social security number, and the like.

As noted above in FIG. 2, in some embodiments, computing-device 220 may be used for various remote viewing (monitoring) 720 activities in near real-time of a session (e.g. an exam session) by accessing data feeds from various monitoring devices (see e.g., FIG. 7B). In some embodiments (e.g. higher stakes embodiments), this may require computing-device 220 to access proxy-server 210 and not server 201 as shown in FIG. 3; that is, embodiments of FIG. 3 for user 401 remote monitoring 720 purposes may be for lower stakes embodiments, such as depicted in FIG. 2D. Remote monitoring 720 during the exam session may require proxy server 210, command device 110, client devices 240, monitoring devices, and/or interactive devices 150 to have access to network 260 during the exam session.

FIG. 4A may depict an organizational structure for how various users 401 of the system and/or the method may be categorized. FIG. 4B may depict the various users 401 of FIG. 4A in how such users 401 may be related to each other as depicted in a Venn diagram.

In some embodiments, users 401 may comprise interactive device users 410, command device and/or proxy server users 420, customers 430, system admin 450, and the like. See e.g., FIG. 4A.

For example, and without limiting the scope of the present invention, interactive device users 410 may comprise: examinees 411, voters 412, students 413, learners, attendees 414, and the like. See e.g., FIG. 4A. Interactive device users 410 may be those individuals who may use interactive devices 150. Examinees 411 may use interactive devices 150 to take exams and tests, including practical exams, i.e. to read, see, and/or hear or otherwise interact with predetermined questions 511 and then to submit their answer 555. Voters 412 may use interactive device to vote. Students 413, learners, and/or attendees 414, may use interactive devices for learning purposes, e.g. for reading, seeing, and/or hearing or otherwise interacting with presented content (e.g. lectures).

For example, and without limiting the scope of the present invention, command device and/or proxy server users 420 may comprise: proctors 421, administrators 422, teachers, instructors 423, professors, lecturers, and the like. See e.g., FIG. 4A. Command device and/or proxy server users 420 may be those individuals who may use command devices 110 and/or who use at least one proxy server 210. Proctors 421 may administer exams to examinees 411, either in person or remotely, depending upon the embodiment and desired level of reliability and security. Administrators 422 may administer voting sessions to voters 412, either in person or remotely, depending upon the embodiment and desired level of reliability and security. Instructors 423 (e.g. professors, teachers, and the like) may administer learning sessions (e.g. lectures, webinars, seminars, and the like) to students 413 or attendees 414, either in person or remotely, depending upon the embodiment and desired level of reliability and security.

In some embodiments, with respect to a particular subject matter, interactive client device users 410 may be a mutually exclusive group with command device and/or proxy server users 420. As maintaining mutual exclusivity between these two groups of users 401 may mitigate against bias and improve security and reliability. See e.g., FIG. 4B.

In some embodiments, customers 430 may comprise third parties 431 and interested parties 435. See e.g., FIG. 4A. Some features of the system and/or the method may be customized by customers 430. For example, and without limiting the scope of the present invention, content may be customized (see e.g. exam building 610 suite or suite 708); customer 430 logos, color schemes, and content layout may also be customized; and also in some embodiments, the quality of video and/or audio capture from various monitoring devices may be predetermined, e.g. by adjusting FPS (frames per second) rate.

For example, and without limiting the scope of the present invention, third parties 431 may comprise: school districts, colleges, universities, private schools, charter schools, public schools, companies, municipalities, certification bodies, licensing bodies, and the like. In some embodiments, the third parties 431 may be responsible for generating the content. In some embodiments, third parties 431 may comprise writers 432, graders 433, and the like. Writers 432 may write, edit, and vet content, including questions (e.g. predetermined questions 511), and including writing answer keys and grading rubrics. Graders 433 may use predetermined grading rubrics to grade completed exams. See e.g., FIG. 4A. In some embodiments, the third parties 431 may be responsible for requesting and/or scheduling exams, votes, lectures, webinars, seminars, and the like. In some embodiments, there may be overlap with third parties 431 and command device and/or proxy server users 420. See e.g., FIG. 4B. For example, and without limiting the scope of the present invention, a proctor 421 may be an employee or agent of a given third party 431.

For example, and without limiting the scope of the present invention, interested parties 435 may comprise: school districts, colleges, universities, private schools, charter schools, public schools, companies, municipalities, certification bodies, licensing bodies, auditing bodies, and the like. In some embodiments, interested parties 435 may comprise auditors 436. Auditors 436 may audit: a particular completed exam, aspects of the system and/or the method; and/or an entirety of the system and/or method. See e.g., FIG. 4A. In some embodiments, an interested party 435 may have an interest in responses to delivered content, e.g., an interest in exam scores or grades. For example, and without limiting the scope of the present invention, a parent of an examinee 411 might be an interested party 435. In some embodiments, there may be overlap with third parties 435 and interested parties 431. See e.g., FIG. 4B. For example, and without limiting the scope of the present invention, a school district might be both a third party 431 and an interested party 435.

In some embodiments, system admin 450 users may be those who actively maintain the methods, systems, and/or devices. In some embodiments, system admin 450 users may be technicians and engineers. In some embodiments, system admin 450 users may be responsible for generating the content (e.g. writing exam questions), validating 645 exam data 550, and grading conducted/administered exams. In some embodiments, system admin 450 users may comprise writers 432, graders 433, auditors 436, and the like. In some embodiments, system admin 450 users may be responsible for requesting and/or scheduling exams, votes, lectures, webinars, seminars, and the like. In some embodiments, system admin 450 users may be employees, consultants, independent contractors, and/or agents of an entity charged with maintaining the methods, systems, and/or devices (including servers 201 and proxy server 210). In some embodiments, there may be overlap with system admin 450 users and interested parties 435, with third parties 431, and/or with command device and/or proxy users 420. See e.g., FIG. 4B.

In some embodiments, all users 401 may have a user-account. In some exemplary embodiments, logging into a user-account may require entry of a username and password. In some embodiments, each user-account depending upon type of user 401 may have different permissions and different functionality associated with the given user-account.

FIG. 5 may depict an organizational structure for how data 501 used in the system and/or the method may be categorized. In some exemplary embodiments, data 501 may be non-transitorily stored on any computer readable media (e.g. memory) associated with the system and/or the method. In some exemplary embodiments, all data 501 or subsets of data 501 may be non-transitorily stored in an encrypted format. In some exemplary embodiments, all movement (traffic) of all data 501 or subsets of data 501 may be done while all data 501 or subsets of data 501 may be in an encrypted format.

In some embodiments, data 501 may comprise question bank 510, exam data 550, and the like. See e.g., FIG. 5.

In some embodiments, question bank 510 may comprise at least one predetermined question 511. Some question banks 510 may comprise a plurality of predetermined questions 511. There may be one or more question banks 510 for any given subject.

In some embodiments, a body of predetermined questions 511 that may be administered during the exam session may comprise question batch 512. Question batch 512 may be a subset of a given question bank 510 or a subset of one or more question banks 510. In some embodiments, question batch 512 may comprise at least one predetermined question 511.

In some embodiments, question banks 510, question batches 512, and predetermined questions 511 may be managed from exam building 610 suite accessed via at least one web-based services 601 provided by at least one server 201.

In some embodiments, each predetermined question 511 may be written, edited, and vetted by writer 432 or system admin 450. Each predetermined question 511 may be generated in an exam building 610 suite accessed via the at least one web-based services provided by at least one server 201. Exam building 610 suite may be testing making software. Exam building 610 suite may permit any given predetermined question 511 to be generated from plain text, embedded video with audio, audio only, video only, pictures, photos, rich text, and the like. Each predetermined question 511 may include an answer key or grading rubric. Each predetermined question 511 may be categorized by subject matter, including multiple levels of sub-subject matter. Each predetermined question 511 may be categorized by question type and/or by subject matter. For example, and without limiting the scope of the present invention, question types may be selected from the group comprising: multiple choice, true/false, matching, short answer, essay, and the like. In some embodiments, predetermined question 511 may test for one or more of: key feature, reading comprehension, math, logic, situational judgment scenarios, hot spot images, jigsaw puzzle assembly, drawing based questions, summary/written response, and the like.

In some embodiments, within exam building 610 suite various randomization options may be selected, with respect to predetermined question 511 delivery to interactive devices 150 and/or with respect to answers 555 (and notes) received from interactive devices 150.

In some embodiments, predetermined questions 511 delivered from at least one server 201 to at least one proxy server 210 or to at least one interactive device 150 may be predetermined. That is, predetermined questions 511 may be predetermined in a sense of that the question was previously written and vetted by third party 431, interested party 435, and/or system admin 450. In some embodiments, predetermined questions 511 may predetermined in a sense that questions to be used for a particular exam session may be determined prior to the exam session being held.

For example, and without limiting the scope of the present invention, in some embodiments, at least one server 201 may receive a selection for a particular question batch 512 to be administered for the particular exam session. In some embodiments, the particular question batch 512 may comprise a finite plurality of predetermined questions 511 selected from a question bank 510. For example, and without limiting the scope of the present invention, a question bank 510 for a particular subject matter may comprise 1,000 unique predetermined questions 511 and the question batch 512 may comprise 100 predetermined questions 511 selected from that 1,000 question bank 510. Such a determination of which predetermined questions 511 may comprise a given question batch 512 may be done in some embodiments by third party 431, interested party 435, and/or system admin 450.

In some embodiments, data 501 may comprise exam data 550. See e.g., FIG. 5. Exam data 550 may be all data, including exam results, obtained for a given administered exam. Exam data 550 may comprise: question batch 512, answer 555, metadata 560, monitoring data 570, check-in data 580, tamper data 590, note module data, calculator module data, date and time stamped flags of particular data, and the like. See e.g., FIG. 5.

In some embodiments, answer 555 may be synonymous with at least one answer 555. A particular answer 555 may be a response to a particular predetermined question 511 that may have asked on a particular exam administration. That is, each answer 555 may generally be paired with each asked predetermined question 511. Note, in some scenarios, an examinee 411 may not answer each predetermined question 511 asked or included in a given question batch 512, and thus there may not an answer 555 for each predetermined question 511 in a given question batch 512. Or alternatively, for such scenarios the system and/or the method may generate a null sell answer 555 to indicate a given predetermined question 511 was not answered by a given examinee 411.

As noted above, delivery of predetermined questions 511 to interactive devices 150 may be done so wherein the delivery of question order may be randomized; likewise a plurality of answers 555 received from interactive devices 150 (e.g. to proxy server 210 and then later to server 201) may also be received in a randomized order. Each delivered predetermined question 511 may be paired with a specific answer 555, paired in a keyed pairing, such that randomization of answers 555 does not destroy the keyed pairing and at server 201 the appropriate answer 555 may then be paired with the appropriate predetermined question 511.

In some embodiments, metadata 560 may comprise user info 561 and/or device info 563. See e.g., FIG. 5. User info 561 may comprise identifying information specific to that given user, e.g. identifying information related to a particular examinee 411. For example, and without limiting the scope of the present invention, such user info 561 may comprise, legal name of individual, bate of birth, physical address, mailing address, social security number, license and/or registration number associated with some professional license/registration, phone number, email address, biometric information, and the like. For example, and without limiting the scope of the present invention, such biometric information may include: photograph images of the particular user 401 (e.g. examinee 411), various fingerprint scans, voice recordings, and the like. Some or all such biometric information have been originally received during an examinee registration process and/or a proctor registration process, which may have temporally preceded exam check-in and exam administration.

Device info 563 may include information related to a specific device, e.g. a specific client device 240, interactive device 150, monitoring device, command device 110, and the like. Such device specific information may include: device name, device type (e.g. a tablet computing device, a laptop, a personal computer (PC), a desktop computer, a smartphone, a smart watch, and the like), device make, device model, device serial number, device MAC address, device IP address, and the like. Metadata 560 may also include which device may be paired with which users 401, by logging an association of specific user info 561 and specific device info 563.

In some embodiments, monitoring data 570 may comprise information generated by various monitoring devices and/or generated by various integral monitoring devices associated with an interactive device 150 and/or with a command device 110.

Check-in data 580 may be generated by proctor 421 and/or examinee 411 entering various inputs into command device 110 and/or interactive devices 150, respectively during the exam check-in 630 phase. In some embodiments, check-in data 580 may comprise metadata 560, user info 561, and/or device info 563. In some embodiments, check-in data 580 may comprise information generated by various monitoring devices and/or generated by various integral monitoring devices associated with an interactive device 150 and/or with a command device 110, generated during the exam check-in phase 630.

In some embodiments, tampering data 590 may comprise information generated by various tamper sensors, which may be configured to detect unscheduled access or access attempts, and/or unscheduled physical movement. Such tamper sensor may be integral with the at least one proxy server 210, the at least one interactive device 150, the at least one command device 110, the at least one monitoring device, and the like. Such tamper sensors may comprise integral gyroscopes and/or accelerometer and/or GPS circuits for detecting physical movement. And/or tamper data 590 may be generated by various integral monitoring devices associated with an interactive device 150 and/or with a command device 110.

FIG. 6 may depict a flow chart of exemplary global steps in the method and used by the system for mobile, reliable, and/or secure testing, voting, and/or learning. In some embodiments, a method for conducting a mobile, secure, and/or reliable exam may comprise the steps of preparing for an exam 625, conducting the exam 635, concluding the exam, receiving exam data 640, and the like.

In some embodiments, preparing for the exam 625 may comprise delivery of at least one predetermined question 511 for use in the scheduled examination from at least one server 201 across network 260 to at least one proxy server 210. At least one predetermined question 511 may be non-transitorily stored within server computer readable media of at least one server 201. At least one predetermined question 511 may be non-transitorily stored within proxy computer readable media of at least one proxy server 210. In some embodiments, conducting the exam 635 may comprise delivering at least one predetermined question 511 from the at least one proxy server 210 to at least one interactive device 150. In some embodiments, concluding the exam may comprise at least one proxy server receiving at least every answer response 555 to each predetermined question 511 from at least one interactive device 150. In some embodiments, the step of receiving exam data 640 may comprise at least one server 201 receiving exam data 550 from at least one proxy server 210.

In some embodiments, the above method for conducting a mobile, secure, and/or reliable exam may comprise additional steps. For example, and without limiting the scope of the present invention, with respect to the exam application of the method, in some embodiments, the method may begin with the system (e.g. server 201) receiving a request for exam 605 to be scheduled and/or administered. That is, the step of receiving request for exam 605 may precede the step of preparing for the exam 625. Such a request may be received from various user 401, e.g. customer 430, and/or system admin 450.

Upon receipt of request 605, server 201 may inquire of the requestor is at least one exam build 609? And in some embodiments, upon receiving request 605, server 201 may check a database residing upon server computer readable media for whether proctors may be available 607 for the requested exam. The step of checking if proctors are available 607 may not be with respect to conflicts in location, date, and/or time; but rather whether qualified proctors may be registered and existing in a proctor pool for the type of exam being requested.

If such proctors may not be available the method may progress to a register proctor 608 suite. The requestor may select desirable proctor credentials. The requestor may open up registration of desirable proctors for a planned exam. Once a predetermined quantity of desirable proctors may be registered and/or available the method may progress to scheduling the exam 615.

If at least one exam may not be built, then the method may progress to a build exam 610 suite. In the build exam 610 suite the requestor may build at least one exam. The requestor may create question bank 510 comprising various predetermined questions 511. The requestor may create various question batches 512 from the predetermined questions 511 of the question bank 510. At least one question batch 512 may comprise at a minimum at least one predetermined question 511 and a maximum to a finite plurality of predetermined questions 511 selected from question bank 510.

In some embodiments, question banks 510, question batches 512, and predetermined questions 511 may be managed from exam building 610 suite accessed via at least one web-based services 601 provided by at least one server 201.

In some embodiments, each predetermined question 511 may be written, edited, and vetted by writer 432 or system admin 450. Each predetermined question 511 may be generated in an exam building 610 suite accessed via the at least one web-based services provided by at least one server 201. Exam building 610 suite may be testing making software. Exam building 610 suite may permit any given predetermined question 511 to be generated from plain text, embedded video with audio, audio only, video only, pictures, photos, rich text, and the like. Each predetermined question 511 may include an answer key or grading rubric. Each predetermined question 511 may be categorized by subject matter, including multiple levels of sub-subject matter. Each predetermined question 511 may be categorized by question type and/or by subject matter. For example, and without limiting the scope of the present invention, question types may be selected from the group comprising: multiple choice, true/false, matching, short answer, essay, and the like. In some embodiments, predetermined question 511 may test for one or more of: key feature, reading comprehension, math, logic, situational judgment scenarios, hot spot images, jigsaw puzzle assembly, drawing based questions, summary/written response, and the like.

In some embodiments, exam building 610 suite may permit inclusion of a calculator to be included with predetermined questions 511 which may require examinees 411 to carry out various arithmetic, computations and/or calculations. For example, and without limiting the scope of the present invention such a calculator may appear on at least a portion of a touchscreen of interactive device 150 when calculations may be needed. Entries received from such calculator may be stored as exam data 550 (e.g. as part of metadata 560) and may be analyzed, reviewed, and/or audited as part of validation 645.

In some embodiments, within exam building 610 suite various randomization options may be selected, with respect to predetermined question 511 delivery to interactive devices 150 and/or with respect to answers 555 (and notes) received from interactive devices 150.

In some embodiments, the requestor may also create answer keys and/or grading rubrics. The requestor may also determine a preferred order of delivery of predetermined questions 511 to examinees 411 during the exam, e.g. such a various methods of randomizing. The requestor may also designate which questions may be for vetting purposes and which may then not be graded, such that once vetted the question may then be used in future examinations. Once at least one exam may be built (e.g. comprising at least one question batch 512) the requestor may be directed or may optionally navigate to scheduling the exam 615.

In some embodiments, if yes proctors are available 607 (from a credential perspective) and/or if yes at least one exam may be built 609, the method may progress to schedule the exam 615. Within the schedule exam 615 suite, the method may direct a series of interactions with the requestor to finalize date of exam, time of exam, location of exam, and whether proctors may be physically available for desired dates, times, and/or locations. Note multiple locations and/or virtual locations may be selected, as well as a desired number of proctors 421 and examinees 411.

In some embodiments, upon receipt of possible dates, times, projected number of examinees 411, and/or exam environment 101 location(s) for the exam from the requestor (e.g. customer 430 or system admin 450), the method may check for proctor 421 availability, in terms of geo and temporal availability. If at least one proctor may be available, then the method may schedule the exam on the received exam date, times, exam environment 101 location(s), and with noted projected number of examinees 411, and/or with at least one proctor 421 assigned to the planned and scheduled session.

In some embodiments, schedule exam 615 suite may permit the requestor to enter a minimum quantity of examinees to register for the exam in order for the exam to not be cancelled. In some embodiments, schedule exam 615 suite may permit the requestor to enter a designated examinee registration window for when prospective examinees may register for the scheduled exam.

Once the exam is scheduled under the schedule exam 615 suite, the method may progress to the step of registering examinees 620. Prospective examinees may register for the scheduled exam using computing-devices 220 to access web-based services 601 provided by server 201. Depending upon a level of security and/or reliability desired for the scheduled exam, prospective examinees may be required to provide certain predetermined user info 561 (see FIG. 5 discussion above regarding user info 561), which may include biometric information specific to each prospective examinee. In some embodiments, registering examinees 620 may occur prior to exam session conduction 635. An examinee registration window (temporal window) with a cutoff date and/or cutoff time for examinee registration may be selected by the requestor at the schedule exam 615 suite.

In some embodiments, prior to the step of conducting the exam, the method may comprise the step of receiving requests from examinees to register 620 for the scheduled examination. Receipt of examinee registration 620 may be from at least one computing-device 220 in communication with the at least one server 201 across the network 260 accessing at least one web-based service 601 provided by at least one server 201. In some embodiments, upon receiving requests from examinees to register for the schedule examination, the method may comprise the step of registering the examinee 620 by non-transitorily storing examinee information within the server computer readable media. Such examinee information may be user info 561.

In some embodiments, upon successful registration of an examinee 411, a unique code, e.g. a barcode, including a QR code or data matrix code, may be delivered (transmitted) to the registered examinee 411. Such a barcode may be used to expedite exam check-in 620.

Receiving the request for the exam 605, registering proctors 608, registering examinees 620, building the exam 610, scheduling the exam 615, and the like may be all be web-based services 601, accessible by user 401 using computing-device 220 across network 260 to access web-based services 601 provided by server 201. System admin 450 may server access station 230 use to access web-based services 601 provided by server 201.

In some embodiments, preparing for the exam 625, exam check-in 630, and exam session conducted 635 may all occur on the same day. Exam check-in 630 and exam session conducted 635 may occur in the same exam environment 101. Some or all of preparing for the exam 625 may also occur in the same exam environment 101 as exam check-in 630 and exam session conducted 635.

In some embodiments, once at least one examinee 411 may be registered or a minimum quantity of examinees 411 may be registered for the scheduled exam, then the method may progress to the step of preparing for the exam 625. Preparing for the exam 625 may comprise delivery of exam instructions to proctor 421. Such delivery may be to command device 110 and/or via email or text message to proctor 421. Such exam instructions may include exam preparation instructions, as well as written instructions to disseminate during exam check-in 630, and/or exam instructions to read aloud to examinees 411 prior to starting the exam session. Preparation instructions may include deployment maps for setting up various monitoring devices.

In some embodiments, preparing for the exam 625 may comprise at least two steps: (1) delivery of exam question batch 627; and (2) physical exam site setup and check 628. Physical exam site setup and check 628 may only be required where exam environment 101 may be a physical location and not a virtual location. Physical exam site setup and check 628 may be conducted at environment 101 (e.g. by proctor 421). Delivery of exam question batch 627 may occur at environment 101 in some embodiments; or off-site in other embodiments.

In some embodiments, delivery of exam question batch 627 may comprise delivery (transmission) of at least one question batch 512 (which may comprise at least one predetermined question 511) to proxy server 210 (in high stakes embodiments), to command device 110, and/or to interactive devices 150. In some exemplary embodiments, at least one proxy server 210 may be battery powered for at least a duration of the exam session.

In some embodiments, at least one proxy server 210 may be in direct communication with at least one interactive device 150, at least during a portion of the exam session. Such direct communication may be either wireless communication or wired communication. In some embodiments, at least one proxy server 210 may be in communication with the at least one interactive device 150 via an intermediary communication device. Such communication may be either wireless communication or wired communication. For example and without limiting the scope of the present invention, the intermediary communication device may be a network router.

In some embodiments, at least one proxy server 210 may be in direct communication with the at least one server 201 for at least of a sufficient duration to receive at least one predetermined question 511. In some embodiments, at least one proxy server 210 may be in direct communication with the at least one server 201 for at least of a sufficient duration to deliver to at least one server 201 at least one answer 555. Such direct communication may be either wireless communication or wired communication. In some embodiments, at least one proxy server 210 may be in communication with the at least one server 201 via an intermediary communication device for at least of a sufficient duration to receive at least one predetermined question 511. In some embodiments, at least one proxy server 210 may be in communication with the at least one server 201 via the intermediary communication device for at least of a sufficient duration to deliver to at least one server 201 at least one answer 555. Such communication may be either wireless communication or wired communication. For example and without limiting the scope of the present invention, the intermediary communication device may be a network router.

In some embodiments, the step of preparing the exam 625 further comprise encrypting at least one predetermined question 511 such that at least one predetermined question 511 received by at least one proxy server 210 may be encrypted. Received at least one predetermined question 511 may be non-transitorily stored in the proxy readable media in the encrypted format.

In some embodiments, the step of preparing the exam may comprise physically preparing exam environment 101, i.e. the step of physical exam site setup and check 628. Exam environment 101 may be at least one physical location wherein the exam session may be conducted. Exam environment 101 may be indoor and/or outdoors. The step of physical exam site setup and check 628 may entail physically transporting the necessary devices to exam environment 101. Necessary devices may comprise one or more of proxy server 210, command device 110; and client device 240, which may further comprise monitoring devices and interactive devices. Necessary devices may also include some ancillary devices, such as tripods, chairs, desks, tables, speakers, routers, modems, internet access points, power supplies, and the like.

In some embodiments, the step of physically preparing 628 exam environment 101 may comprise locating at least a quantity of monitoring devices within exam environment 101 such that every proctor 421 and every examinee 411 planned to be substantially within the exam environment 101 during the exam session may resides within at least one monitoring device's zones of operation. “Substantially” as used in this context was discussed above. And zones of operation were also discussed above.

In some embodiments, the step of physically preparing 628 exam environment 101 may comprise positioning at least one monitoring device such that every proctor 421 and every examinee 411 planned to be substantially within exam environment 101 during the exam session may reside within at least one monitoring device's zones of operation. “Substantially” as used in this context was discussed above. And zones of operation were also discussed above.

In some embodiments, the step of physically preparing 628 exam environment 101 may comprise removably attaching at least one wearable monitoring device to each proctor 421, or one or more proctors 421; and/or to one or more examinees 411. In some embodiments, the step of physically preparing 628 exam environment 101 may comprise removably attaching at least one wearable monitoring device to each examinee 411; or to one or more examinees 411.

In some embodiments, the step of physically preparing 628 exam environment 101 may comprise a proctor 421 by use of command device 110 in communication with each monitoring device (or at least a portion of the present monitoring devices), verifying that every proctor 421 and/or every examinee 411 planned to be within the exam environment 101 during the exam session may resides substantially within at least one monitoring device's zones of operation. “Substantially” as used in this context was discussed above. And zones of operation were also discussed above.

In some embodiments, once preparing for the exam 625 may have been completed, the method may progress to exam check-in 630. In some embodiments, prior to conducting the exam, examinees 411 for the scheduled examination may be checked-in in step 630. Exam check-in 630 may comprise proctors 421 verifying examinee 411 user info 561. The step of checking-in 630 examinees 411 may comprise verifying examinee 411 identification. Such examinee 411 identification may be verifying a government issued identification (e.g. driver's license, passport, social security card, and the like), examinee 411 date of birth, examinee 411 social security number, biometrics information (such as photographs of examinee 411, voice of examinee 411, fingerprint(s) of examinee 411, and the like).

Exam check-in 630 may comprise proctors 421 updating examinee 411 biometric information for comparison to examinee registration biometric information. Exam check-in 630 may comprise proctors 421 associating examinees 411 with specific interactive devices 150 by logging device info 563. That is, the step of checking-in 630 examinees 411 may comprise logging (documenting) association of each examinee 411 with a particular interactive device 150. The step of checking-in 630 examinees 411 may comprise building and/or generating an examinee seating chart. Exam check-in 630 may conclude with proctors 421 disseminating exam instructions and/or proctors orally presenting exam instructions to examinees (which may be augmented by microphone and speakers).

In some embodiments, the step of checking-in 630 examinees 411 may comprise at least one proxy server 210 receiving check-in data 580 and non-transitorily storing the check-in data 580 in the proxy readable media. In some embodiments, the received and non-transitorily stored check-in data 580 may be encrypted.

In some embodiments, once exam check-in 630 may be completed the method may progress to exam session conducted 635. During exam session conducted 635 predetermined questions 511 may be delivered to interactive devices (e.g. by proxy server 210) and/or answers 555 may be received from interactive devices 150. The step of monitoring exam 637 by one or more monitoring devices, including integral monitoring devices in some embodiments, may occur concurrently with exam session conducted 635. Monitoring data 570 obtained during step of monitoring exam 637 may be linked in real-time to answers 555 received for at least near real-time correlation and/or subsequent validation and/or forensics review.

In some embodiments, at least one server 201 may receive a selection for a particular question batch 512 to be administered for the particular exam session. The particular question batch 512 may comprise a finite plurality of predetermined questions 511 selected from question bank 510. In some embodiments, the method may comprise delivery (transmission) from at least one server 201 to at least one proxy server 210 the entire particular question batch 512. This delivery (transmission) may occur at the step of deliver exam question batch 627 noted above—which may or may not precede the step of exam check-in 630.

In some embodiments, during the exam session, i.e. during the step of exam session conducted 635, at least one proxy server 210 may deliver to each interactive device 150, from a plurality of interactive devices 150, the entire delivered question batch 512, such that each interactive device 150 may receive question batch 512 with the finite plurality of predetermined questions 511 in a randomized order; such that an order in which an examinee 411 may read, see, and/or hear any individual predetermined question 511 may be random.

In some embodiments, during the exam session, i.e. during the step of exam session conducted 635, at least one proxy server 210 may deliver to each interactive device 150, from a plurality of interactive devices 150, one predetermined question 511 at a time, selected at random, from the question batch 512, such that each interactive device 150 may receive one predetermined question 511 at a time delivered in a randomized order for each interactive device 150; such that an order in which an examinee 411 may read, see, and/or hear any individual predetermined question 511 may be random.

In some embodiments, when at least one proxy server 210 may receive a request from one of the interactive devices 150 for delivery of one predetermined question 511, the method may comprise retrieving any presently residing predetermined question 511 from the interactive device 150 before delivering a next predetermined question 511 to the interactive device 150, such that at any given time during the exam session, only one predetermined question 511 may reside on any interactive device 150 associated with the exam session.

In some embodiments, the step of conducting the exam 635 may comprise delivering at least one predetermined question 511 to at least one interactive device 150 in an encrypted format. In some embodiments, the at least one interactive device may comprise a decrypting means so the at least one predetermined question 511 delivered by the at least one proxy server 210 may be presented to an examinee 411 utilizing the at least one interactive device 150 in a decrypted fashion.

In some embodiments, the step of conducting the exam 635 may comprise at least one proxy server 210 receiving at least one answer 555 response to the at least one predetermined question 511 from the at least one interactive device 150.

In some embodiments, the step of conducting the exam 635 may comprise at least one proxy server 210 receiving at least one answer 555 response in an encrypted format. In some embodiments the received at least one answer 555 in the encrypted format may be non-transitorily stored within the proxy computer readable media, at least until uploaded to server 201 and such upload may be verified.

In some embodiments, the step of conducting the exam 635 may comprise the step of monitoring 637 exam environment 101 during the exam session using at least one monitoring device. The at least one monitoring device may generate monitoring data 570 which may be received by the at least one proxy server 210. In some embodiments, the at least one monitoring device may be positioned such that every proctor 421 and/or every examinee 411 within exam environment 101 or at least a portion of the exam session may resides within at least one monitoring device's zones of operation. In some embodiments, monitoring data 570 that may be received by at least one proxy server 210 may be in an encrypted format.

In some embodiments, the step of conducting the exam 635 may comprise the step of monitoring 637 exam environment 101 during the exam session using at least one integral monitoring device. The at least one integral monitoring device may generate monitoring data 570 which may be received by the at least one proxy server 210. The at least one integral monitoring device may integral with at least one interactive device 150 and/or with at least one command device 110. In some embodiments, such monitoring data 570 received by at least one proxy server 210 from integral monitoring device may be received in an encrypted format.

In some embodiments, the step of concluding the exam may comprise at least one proxy server 210 receiving all exam data 550, including every answer 555 response to each predetermined question 511 delivered to at least one interactive device 150, and received from the at least one interactive device 150.

In some embodiments, exam data may be selected from one or more of the group comprising: each predetermined question 511 delivered to the at least one interactive device 150 (which may comprise delivered question batch 512), including the at least one predetermined question 511; each answer 555 to each predetermined question 511, including the at least one answer 555; monitoring data 570; check-in data 580; tampering data 590; metadata 570; and the like.

In some embodiments, all data received (e.g. exam data 550) by at least one proxy server 210 may be encrypted. Data received by proxy server 210 may be non-transitorily stored within the proxy readable media, at least until upload of the data to server 201 may be verified.

In some embodiments, once a defined duration for the exam session may have lapsed, the method may not permit grading of any answer 555 submitted after the duration has lapsed. In some embodiments, once a defined duration for the exam session may have lapsed, the method may flag any answer 555 submitted after the duration has lapsed, wherein such flagging may indicate the late answer must receive a score of zero or of no credit.

In some embodiments, once all (or substantially all) exam data 550 may be received by proxy server 210 (or other devices, such as command device 110, client devices 240, and the like), such exam data 550 may then be uploaded to server 201 via the step of receiving exam data 640. The step of receiving exam data 640 may be a server side 602 function, occurring at server 201. In some embodiments, exam data 550 received by the at least one server 201 from the at least one proxy server 210 may be encrypted. Once such exam data 550 may be received by server 201 such exam data 550 may be non-transitorily stored within the server computer readable media.

Upon exam data 550 receipt by server 201, the method may progress to validating the exam 645. (In some embodiments, some validation may occur at proxy server 210, e.g. data integrity checking and verification.) The step of validation 645 may comprise examining received data (e.g. exam data 550) for data integrity; evidence of tampering; evidence of proctor 421 bias (conflict of interest); evidence of examinee 411 cheating; evidence of question theft; further manual review of automatically or manually flagged data; grading; and the like. Evidence of tampering (e.g. with proxy server 210); evidence of proctor 421 bias (conflict of interest); evidence of examinee 411 cheating; evidence of question theft; further manual review of automatically or manually flagged data; and the like may be handled by a forensics module of the executable code (and/or the proxy executable code).

The step of validating the exam 650 may comprise routine data integrity checking for missing data and/or data transmission errors, and if found may prompt proctor 421 to resend exam data 550 to server 201 before exam data 550 may be deleted from proxy server 210 (or command device 110 or any other device exam data 550 may have been residing upon for that embodiment). (Note, in some embodiments, proxy server 210 may perform a similar routine data integrity checking for missing data and/or data transmission errors prior to enforcing deletion of any exam data from client devices 240, such interactive devices 150 and monitoring devices.)

During the session, monitoring devices and/or interactive devise, as well as command device 110 may all be generating various forms of exam data 550, in a continuous or near continuous manner (subject to capture/generation rates). In some embodiments, all or substantially all exam data 550 received by proxy server 210 (or equivalent device) may be automatically reviewed and/or re-reviewed by the forensics module, checking for various possibilities of improprieties. For example, and without limiting the scope of the present invention, biometric data (e.g. user info 561) obtained during examinee registration 620 and/or obtained during exam check-in 630 may then be compared (automatically by software in some embodiments) with biometric data obtained from monitoring devices during the session, looking possible changes in examinee 411 biometric data which may indicate a possible impropriety. For example, and without limiting the scope of the present invention, audio data may be analyzed by using fast Fourier transformation analysis for possible improprieties. Possible identified improprieties may be flagged.

In some embodiments, the system and/or the method may comprise an ability to flag captured data (e.g. exam data 550). Flagging may comprise adding a date and time stamp annotation to all linked data associated with the possible impropriety. For example, if the possible impropriety relates to one specific examinee 411, any monitoring data 570 which may include that specific examinee 411 within its zone of operate may be flagged with the date and time stamp, as well as the predetermined question 511 and possible answer 555 that may also correspond in time to the possible impropriety.

In some embodiments, flagging of data may be done manually by proctor 421, e.g. if proctor 421 may notice a possible impropriety. In some embodiments, some flagging of data may be done automatically by the system and/or method by the forensics module (e.g. fast Fourier transformation analysis of audio for possible impropriety, receipt of tampering data 590, and the like). Automatic data flagging may also generate an alert transmitted to proctor 421, e.g. to command device 110, such the flagged data may be reviewed timely. In some embodiments, flagged data reviewable during the session may comprise monitoring data 570 and/or tamper data 590; but in some embodiments not predetermined questions 511 nor answers 555, which may be kept encrypted from proctors 421. The alert received by command device may be visual, auditory, vibrational, or some combination. In some embodiments, alerts may also be transmitted by proxy server 210 to server 201. In some embodiments, flagged data may also be reviewed during validation 645.

Upon validation 645, uploaded exam data 550 (e.g. to server 201), particularly exam data 550 with at least one flag may be reviewed by system admin 450, and/or auditor 436. A report may be provided to system admin 450 and/or auditor 436 which may comprise any flags, depicted by flag icons in some embodiments, raised during the session. From the report system admin 450 and/or auditor 436 may click on any given flag icon, which may then provide links to each item of exam data 550 associated with the chosen flag for further investigation and analysis.

In some embodiments, part of validation 645 and/or the forensics module, may comprise pixel tracking and/or pixel counting which may occur as interactions with touchscreens may be received. Pixel tracking and/or pixel counting may be used in particular with analysis of proctor 421 and/or examinee 411 signatures entered on a touchscreen device. Pixel tracking and/or pixel counting may be used in other inputs entered via touchscreens. For example, and without limiting the scope of the present invention, if too few pixels may be detected below a predetermined threshold, such input may be flagged as a possible impropriety and/or the interactive device 150 (or command device 110) wherein the input was entered may be paused and the input may be requested again.

In some embodiments, the system and/or the method may comprise a note mode. In some embodiments, examinees 411 may enter at least one note using an input device associated with the interactive device 150 (e.g. a touchscreen). In some embodiments, proctors 421 may enter at least one note using an input device associated with the command device 110 (e.g. a touchscreen). This note mode may enable various users 401 (e.g. examinees 411 and proctors 421) an ability to write their notes, which may then be preserved in a digital format and non-transitorily stored in proxy computer readable media, as a component of exam data 550. Such notes may be comprise a date and time stamp and correlation (linkage) to exam data 550 associated with the note (much like the flagging functionality). Such notes may then be analyzed and/or reviewed during validation 645.

In some embodiments, the system and/or the method may comprise interaction annotation, monitoring data annotations based on user responses, and/or event annotation, both of which may first involve interaction tracking. In some embodiments, the system and/or the method may track user 401 (e.g. examinee 411 or voter 412) interactions with a given displayed content item (e.g. predetermined question 511). For example and without limiting the scope of the present invention, interactions may be clicking on, selecting, swiping, having a cursor hover over an area of the screen for at least a predetermined time and the like. When the system and/or method detects such an interaction, the interaction may be flagged, with date and time stamp, as well linked to concurrent monitoring data 570 which may have also captured the interaction. Then upon validation 645, the flagged interaction along with linked monitoring data 570 may all be reviewed, analyzed (for improprieties and/or for statistical information), and the like.

For example and without limiting the scope of the present invention, user 401 may click on a displayed content item (e.g. displayed on interactive device 150 GUI), that click may then be detected and logged (i.e. flagged) with a date and time stamp in the system (e.g. in the exam data 550) and then when the exam (or voting session) gets submitted (uploaded), auditor 436 may be explicitly visually notified of the flag and may see “oh . . . this user clicked on item 5's answer at 15:06 PM” . . . when auditor 436 may clicks on that date time stamp flag link it may take auditor 436 to that date and time in relevant monitoring data 570 (e.g. video data).

In some embodiments, concurrently with validating 645, subsequently after validating 645, or absent validation 645, grading may occur. Every answer 555 as a subset of exam data 550 received by at least one server 201 (e.g. from the at least one proxy server 210) may be automatically graded against a predetermined answer key (exam key) and/or may be graded manually by a grader 433 using a predetermined grading rubric—unless a given answer 555 was submitted after the duration for the exam session terminated, in which case such a late submitted answer 555 may be flagged or automatically graded as no credit received and may be treated as a non-answered question.

In some embodiments, concurrently with validating 645, subsequently after validating 645, or absent validation 645, the step of providing exam feedback 650 may occur. Exam feedback may comprise exam feedback content. Exam feedback content may comprise grades and/or exam statistics. Both grades and exam statistics may exist in two formats, personalized for a particular participating examinee 411 and general or public, wherein examinee 411 personal information has been removed. A particular participating examinee 411 may have access to their own personalized grading results and to the general or public results; whereas, some interested parties 435 or the public may only have access to the general or public results.

In some embodiments, upon the exam data 550 received by at least one server 201 from at least one proxy server 210, and upon validation 645 and/or grading, at least one exam grade and/or exam statistics may be made available for access by authorized users. In some embodiments, the at least one exam grade and/or the exam statistics may be delivered from at least one server 201 to webpages accessible by the authorized user; as well as to predetermined email accounts, text accounts, and/or voicemail accounts associated with the authorized user. Such webpages may be hosted by the web-based services 601 provided by server 201 and may accessible by use of computing-device 220 in communication with network 260 to reach server 201.

In some embodiments, each individual participating examinee 411 may have access to their own individual exam grades and/or individual exam statistics as well as to the overall general or public exam statistics which may be devoid of examinee 411 personal information. Such individual participating examinees 411 may have such access by using a computing-device 220 to log into their account and access the appropriate web-based service 601 provided by server 601. Such individual participating examinees 411 may have such access by receiving pushed exam feedback content to the examinee's 411 email, voicemail, and/or text message. In some embodiments, the method and/or the system may also automatically print hard copy letters for physical mailing of such exam feedback content to the examinee's 411 physical mailing address.

FIG. 7A, FIG. 7B, and FIG. 7C may depict a single flow chart, divided into three consecutive figures, wherein the single flow char may depict exemplary global steps in a method and used by the system for mobile, reliable, and/or secure testing, voting, and/or learning. The steps depicted in FIG. 7A may be steps carried out in the server side 602, and wherein where a step may require input from a user 401, such input may be provided as a web-based service 601 provided by server 201. Or some results of the steps of FIG. 7A may be accessible by user 401 accessing web-based-services 601. The steps depicted in FIG. 7B may be carried out at environment 101. The steps depicted in FIG. 7C may be steps carried out in the server side 602, and wherein where a step may require input from user 401, such input may be provided as a web-based service 601 provided by server 201. Or some results of the steps of FIG. 7C may be accessible by user 401 accessing web-based-services 601.

In some embodiments, the method for conducting a mobile, secure, and/or reliable exam may comprise the steps of preparing for an exam (steps 711, 712, and 722), conducting the exam (steps 713 through 716), receiving exam data 725, and the like.

Now discussing FIG. 7A, prior to the step of preparing of the exam, the method may receive a customer request 701. The request from customer 430 or system admin 450—herein after the requestor—may be for an exam, a voting session, and/or for learning. Upon receiving request 701, the method may determine if customer content currently exists by step 702. The content may comprise a preexisting built exam (e.g. question batch 512), a preexisting built voting ballot (voting content), and/or preexisting learning content (e.g. lessons). The content may also include selected session parameters (such as whether step 717 may be selected). If customer content may exist, then such content may be selected by the requestor for linking to a session (e.g. an exam session). Alternatively, if no preexisting customer content exists, the method may direct the requestor to build content 708 suite. For the exam application build content 708 suite may be synonymous with build exam 610 suite. Once content may be built, the requestor may be directed to step 703, for content linkage to the planned session.

In some embodiments, once content linkage may be accomplished in step 703, the method may direct the requestor to step 704, wherein the method may inquire if a desired physical site (e.g. environment 101) may be available for administering (conducting) the linked content. If such a physical site may be available, the physical site information may then be linked to linked content at step 705. The linked session content may now include not only the content to be administered but also the physical location for administration (e.g. environment 101). Such linked session and physical site information may be made accessible to the public and/or interested parties 435 via web-based services 601 provided by server 201.

Alternatively, if the desired physical site may not be available or if one is not known, the method may prompt the requestor to enter in a physical site information, or select from a list of physical site, or select administration at a virtual location, i.e. for administration to be conducted over the internet (e.g. in home testing). Again, once the method may receive the physical site information or virtual location selection, the method may progress to step 705 for linkage of the physical location information (or virtual location selection) with the other previously linked content information of step 703.

In some embodiments, upon completion of step 705, the method may progress to step 706, wherein users of the linked content may be permitted to registered for the now scheduled administration. For example, and without limiting the scope of the present invention, examinees 411, or voters 412, or students 413, or attendees 414 may then register for the scheduled administration. Such registration may occur through web-based services 601 provided by server 201.

In some embodiments, either subsequent to registration step 706 or concurrently with step 706, step 707 of assigning proctors 421 (or administrators 422 or instructors 423) to the scheduled administration may occur. If proper proctors may be available, the method may progress to step 711, addressed in FIG. 7B. If proctors may not be available, the method may progress to step 710, of registering proctors and/or of assigning proctors from a proctor pool. The proctor pool may reside upon a database non-transitorily stored in server computer readable media; and newly registered proctors may be added to such a proctor pool. Once proctors may be registered and then assigned, the method may progress to step 711, addressed in FIG. 7B.

Now turning to FIG. 7B. The steps of preparing for the exam may comprise steps 711, 712, and 722. In step 711 proctors 421 (or administrators 422 or instructor 423) may download from server 201 the linked content (e.g. question batch 512) to proxy server 210 and/or to various devices (e.g. command device 110, client devices 240). Such download may occur via step 722, of pushing (e.g. across network 260) the linked content from server 201 to proxy server 210 and/or to various devices (e.g. command device 110, client devices 240). In step 722 server 201 may deliver (transmit) and proxy server may receive the linked content. In some embodiments, steps 711 and 722 may be synonymous with steps 625, 627, and 628 when the linked content may be for an examination.

In some embodiments, upon completion of step 722 and 711, the method may progress to step 712. Step 712 may entail executing some pre administration confirmations, such as confirming session details and examinee 411 (or voters 412, or students 413, or attendees 414) details on the day of the session administration. In some embodiments, step 712 may be synonymous with steps 628 and 630 when the linked content may be for an examination.

In some embodiments, upon completion of step 712, the method may progress to step 713. In step 713 the session may start. Content may be administered. In some embodiments, the content may be pushed from proxy server 210 to interactive devices 150. Administration of content may occur as discussed above, e.g. via randomized predetermined question 511 delivery to interactive devices 150. Proxy server 210 may be receiving exam data 550 from client devices 240, such as interactive devices 150 and/or monitoring devices; as well as receiving data (e.g. monitoring data 570) from command device 110.

In some embodiments, once the session may be started per step 713 or in operation, under step 718, the session may be monitored by the at least one monitoring device. Step 718, i.e. of monitoring the session with at least one monitoring device, may be occurring during steps 713, 714, 715, and 716.

In some embodiments, step 713 may transition into step 716, without incurring steps 714 or step 715. That is, in some embodiments, steps 714 and 715 may be optional. Step 714 may involve proctors 421 (or administrator 422 or instructors 423) using command device 110 to monitor monitoring data 570, either in real-time, near real-time, or for flagged data.

In step 715 may involve proctors 421 (or administrator 422 or instructors 423) pausing and resuming administration of the content for various reasons (e.g. because of a potential impropriety that may have been flagged or to make an announcement), i.e. of stopping and restarting administration of the session. Step 715 may involve stopping the entire administration for all examinees 411 or only for a selected number of examinees 411. Pausing and/or resuming administration may be carried by command device 110 sending a command to proxy server 210, which in turn may send appropriate pause and/or resume signals to selected interactive devices 150. Similarly, step 715 may involve proctor 421 via command device initiating a scramble command sent to proxy server 210 which in turn may scramble displayed content on selected interactive devices 150.

In some embodiments, step 716 may commence either upon reaching the end of the predetermined duration for the session or upon proxy server 210 receiving all answers 555 or all responses to delivered content. All session materials (e.g. interactive devices 150 in some embodiments) may be collected by proctor 421 during step 716.

In some embodiments, proctor 421 may use command device 110 to verify if all exam data 550 may have been received by proxy server 210 (or alternatively the method may do so automatically); and if so, may initiate a command sent to proxy server 210 to make sure all exam data 550 may be deleted from client devices 240, in particular from interactive devices 150.

In some embodiments, proctor 421 may use command device 110 to verify if all exam data 550 may have been received by proxy server 210 (or alternatively the method may do so automatically); and if so, may initiate a command sent to proxy server 210 to make sure all exam data 550 may be deleted from client devices 240, in particular from interactive devices 150; and then to subsequently order all interactive devices powered down or otherwise rendered inoperable. Upon completion of step 716, the method may progress to step 725, depicted in FIG. 7C.

Continuing discussing FIG. 7B, in step 717, feedback from the administered content may be provided. For example, and without limiting the scope of the present invention, if the deployment of this session included “instant results,” such as grades, the instant results may be made available to examinees 411. For example, and without limiting the scope of the present invention, where grading may not be dependent upon other examinee 411 performance (e.g. “curved”), then upon an examinee 411 submitting a last answer 555, the next displayed screen content on the interactive device 150 may display the examinee's grade and/or exam results.

Step 720 may involve remote monitoring of the administered session in real-time or near real-time (accounting for transmission lag). Step 720 may be proceeded by step 719, wherein remote user 401 must first log into the system and/or method to access remote monitoring 720. Remote monitoring 720 may require that proxy server 210 have an internet connection or connection to network 260; and that at least one monitoring device per step 718, may be providing monitoring data 570 to proxy server 210.

In step 721, which conceptually may be an expansion of remote monitoring 720, in that in step 721 all exam data 550, not just monitoring data 570, as generated and transmitted to proxy server 210 may then be transmitted back to server 201. In some embodiments, step 721 may be an alternative or backup to step 725 (see FIG. 7C). Exam data 550 received via step 721 may be archived and non-transitorily stored on server computer readable media, e.g. for future validation, forensics analysis, grading, statistical analysis, and the like.

Now turning to FIG. 7C. In step 725, exam data 550 received by proxy server 210 may then be uploaded to server 201. This may entail proctor 421 manually initiating an upload command from command device 110 (or directly from proxy server 210) to proxy server 210. And/or this upload may occur automatically completion of step 716. In some embodiments, if an upload error may occur, the method may progress to step 731, wherein exam data 550 (encrypted in high stakes embodiments) may be temporarily stored within proxy server 210 until a successful upload may be confirmed. Step 726 may comprise confirmation of a successful upload of exam data 550 to server 201 from proxy server 210. If step 726 confirms a successful upload, then step 727 may check for data integrity. If there may be a gap in the uploaded (received) exam data 550, the method may progress to step 732, wherein exam data 550 (encrypted in high stakes embodiments) may be temporarily stored within proxy server 210 until a new exam data 550 upload may be performed. If in step 727 the exam data 550 passes integrity analysis, then step 729 may cause exam data 550 to be deleted from proxy server 210. If in step 727 the exam data 550 passes integrity analysis, then step 728 may initiate exam data 550 validation (e.g. step 645), grading, statistical analysis, and the like—culminating in providing administered content feedback (e.g. step 650). Lastly, the method then terminates at step 730 with conclusion of that administered content session.

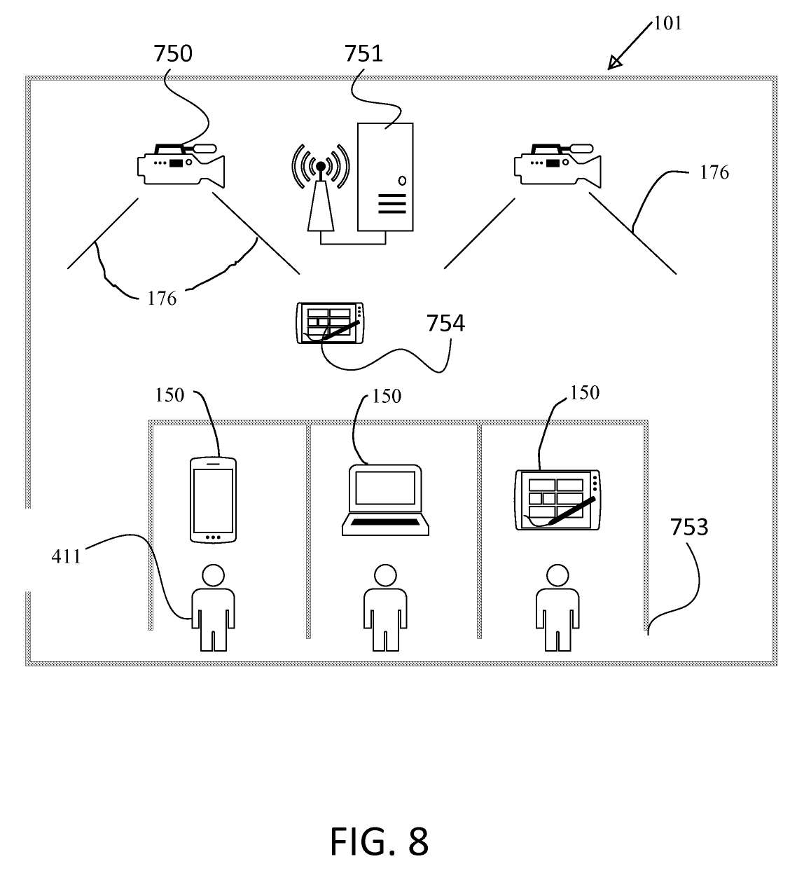

FIG. 8 may depict deployment of aspects of a system and/or a method for mobile and reliable voting, wherein a voting session may be conducted in a voting environment, wherein the voting environment may be an isolated room, all shown from a top view. As noted above, voting application embodiments may use the same hardware and software as utilized in exam application embodiments, with a difference being in the content delivered to interactive devices being ballots instead of exam questions. However, even ballots from a data delivered and received standpoint may be equivalent to predetermined questions 511 and answers 555.

In some embodiments, FIG. 8 may depict a voting scenario/deployment embodiment, where ballots may be cast by voters 412, either en mass (scalability only limited by processing power and/or bandwidth) or in an isolated cubicle (booth) 753. For voting, where reliability and security may be paramount and in the best interests of voters 412 and possibly candidates, monitoring devices 750 (e.g. cameras and/or microphones) may be used to record the voting session. At least one secure proxy 751 (e.g. as described above under FIG. 2, FIG. 2A, FIG. 6, and FIG. 7) may be used in conjunction with at least one interactive device 150. At least one secure proxy 751 may capture (receive) voter feedback and responses (e.g. equivalent to answer 555) and may securely store voter session data (e.g. equivalent to exam data 550) for timely transmission to remote (cloud) servers 201. An optional control device 754 may be present to facilitate, monitor ballot counts, interface with voters 412 to provide assistance, maintain security by remotely monitoring progress and usage, and the like. Optional control device 754 may be equivalent to command device 110 in terms of structure and/or function. Proxy 751, control device 754, and/or monitoring devices 750 may be optional for some voting session deployment embodiments of the present invention.

A system and method for conducting mobile, reliable, and/or secure testing, voting, and/or learning has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1-3. (canceled)

31. A method for conducting a reliable exam, comprising the steps of:
(a) preparing for an exam; wherein preparing for the exam comprises non-transitory storage of exam data within server computer readable media of at least one server; wherein the exam data comprises at least one predetermined question;
(b) conducting the exam; wherein conducting the exam comprises delivering the at least one predetermined question from the at least one server to at least one interactive device; wherein each delivered of the at least one predetermined question generates at least one answer in response; wherein the exam data further comprises each of the at least one answer; and
(c) receiving the exam data; wherein the step of receiving the exam data comprises the at least one server receiving the exam data from each of the at least one interactive devices.

32. The method for conducting the reliable exam according to claim 31, wherein the step of preparing the exam further comprises delivery of the exam data for use in a scheduled examination from the at least one server to at least one proxy server before delivery of the exam data is delivered to the at least one interactive device, wherein the exam data is non-transitorily stored within proxy computer readable media of the at least one proxy server; wherein the step of preparing the exam further comprises the at least one proxy server delivering the at least one predetermined question to the at least one interactive device;
wherein the method further comprises concluding the exam after the conducting the exam, but before the receiving the exam data; wherein the concluding the exam comprises the at least one proxy server receiving from the at least one interactive device the at least one answer in response to each predetermined question from the at least one predetermined questions delivered to each of the at least one interactive devices; and wherein the concluding the exam further comprises removing the exam data from the least one interactive device; and
wherein in the receiving the exam data, the at least one proxy server delivers the exam data from the at least interactive device to the at least one server;
wherein the at least one proxy server is in communication with one or more of: the at least one interactive device, at least one command device, or at least one monitoring device during an exam session;
wherein the at least one proxy server is in communication the at least one server during the preparing the exam and during the receiving the exam data;
wherein the communication is one or more of wireless communication or wired communication.

33. The method for conducting the reliable exam according to claim 32, wherein the at least one proxy server is in communication with the at least one server for at least of a sufficient duration to receive the at least one predetermined question; and wherein the at least one proxy server is in communication with the at least one server for at least of a sufficient different duration to deliver to the at least one server the at least one answer.

34. The method for conducting the reliable exam according to claim 32, wherein the exam data received by at least one proxy server is encrypted with the exam data non-transitorily stored within the proxy computer readable media of the at least one proxy server.

35. The method for conducting the reliable exam according to claim 32, wherein the at least one server receives a selection for a particular question batch to be administered for the exam session; wherein the particular question batch comprises a finite plurality of predetermined questions selected from a question bank; wherein the method further comprises delivery from the at least one server to the at least one proxy server the entire particular question batch; wherein the at least one proxy server delivers to each interactive device from a plurality of interactive devices, one or more of the finite plurality of predetermined questions, such that each interactive device receives the one or more of the finite plurality of predetermined questions in a randomized order, such that an order in which an examinee sees any individual predetermined question is random with respect to a different examinee.

36. The method for conducting the reliable exam according to claim 31, wherein the step of preparing the exam further comprises encrypting the at least one predetermined question such that the at least one predetermined question received by one or more of the at least one interactive device or at least one proxy server is encrypted.

37. The method for conducting the reliable exam according to claim 31, wherein one or more of at least one proxy server, the at least one interactive device, at least one command device, or at least one monitoring device are battery powered for at least a duration of an exam session.

38. The method for conducting the reliable exam according to claim 31, wherein the at least one server receives a selection for a particular question batch to be administered for an exam session; wherein the particular question batch comprises a finite plurality of predetermined questions selected from a question bank; wherein the method further comprises delivery from the at least one server to each interactive device from a plurality of interactive devices, one or more of the finite plurality of predetermined questions, such that each interactive device receives the one or more of the finite plurality of predetermined questions in a randomized order, such that an order in which an examinee sees any individual predetermined question is random with respect to a different examinee.

39. The method for conducting the reliable exam according to claim 38, wherein when the at least one server receives a request from one of the interactive devices for delivery of one predetermined question selected from the particular question batch, the method further comprises retrieving any presently residing predetermined question from the interactive device before delivering a next predetermined question to the interactive device, such that at any given time during the exam session, only one predetermined question resides on any interactive device associated with the exam session.

40. The method for conducting the reliable exam according to claim 31, wherein the step of preparing the exam further comprises physically preparing an exam environment, wherein the exam environment is a physical location wherein an exam session is to be conducted.

41. The method for conducting the reliable exam according to claim 40, wherein the step of physically preparing the exam environment comprises locating at least a quantity of monitoring devices within the exam environment such that every proctor and every examinee planned to be substantially within the exam environment during the exam session resides within at least one monitoring device's zones of operation.

42. The method for conducting the reliable exam according to claim 40, wherein the step of physically preparing the exam environment comprises positioning at least one monitoring device such that every proctor and every examinee planned to be substantially within the exam environment during the exam session resides within at least one monitoring device's zones of operation.

43. The method for conducting the reliable exam according to claim 40, wherein the step of physically preparing the exam environment comprises removably attaching at least one wearable monitoring device to one or more of each proctor or each examinee.

44. The method for conducting the reliable exam according to claim 40, wherein the step of physically preparing the exam environment comprises a proctor by use of a command device in communication with each monitoring device, verifying that every proctor and every examinee planned to be within the exam environment during the exam session resides substantially within at least one monitoring device's zones of operation.

45. The method for conducting the reliable exam according to claim 31, wherein prior to conducting the exam, examinees for a scheduled examination are checked-in; wherein the step of checking-in examinees comprises one or more of the following: verifying examinee identification, logging association of each examinee with a particular interactive device, or the at least one server receiving check-in data and non-transitorily storing the check-in data in the server computer readable media.

46. The method for conducting the reliable exam according to claim 31, wherein the step of conducting the exam comprises delivering the at least one predetermined question to the at least one interactive device in an encrypted format.

47. The method for conducting the reliable exam according to claim 46, wherein the at least one interactive device comprises a decrypting means so the at least one predetermined question received by the at least one interactive device is presented to an examinee utilizing the at least one interactive device in a decrypted fashion.

48. The method for conducting the reliable exam according to claim 31, wherein the step of receiving the exam data comprises the at least one server receiving each of the at least one answers in an encrypted format.

49. The method for conducting the reliable exam according to claim 31, wherein the step of conducting the exam comprises monitoring an exam environment during an exam session using at least one monitoring device, wherein the at least one monitoring device generates monitoring data which is received by one or more of the at least one server or at least one proxy server.

50. The method for conducting the reliable exam according to claim 49, wherein the monitoring data received is in an encrypted format.

51. The method for conducting the reliable exam according to claim 31, wherein the step of conducting the exam comprises monitoring an exam environment during an exam session using at least one integral monitoring device, wherein the at least one integral monitoring device generates monitoring data which is received by one or more of the at least one server or at least one proxy server; wherein the at least one integral monitoring device is integral with one or more of the at least one interactive device or at least one command device.

52. The method for conducting the reliable exam according to claim 31, wherein the step of receiving the exam data comprises the at least one server receiving the exam data from one or more of the at least one interactive device, at least one command device, at least one monitoring device, or at least one proxy server that in turn receives the exam data from one or more of the at least one interactive device, the at least one command device, or the at least one monitoring device.

53. The method for conducting the reliable exam according to claim 31, wherein the exam data is selected from one or more of the group consisting of: a question bank, the at least one answer, metadata, monitoring data, check-in data, and tamper data; wherein the question bank comprises each predetermined question from the at least one predetermined question delivered to each of the at least one interactive devices.

54. The method for conducting the reliable exam according to claim 31, wherein the exam data received by the at least one server is encrypted with the exam data non-transitorily stored within the server computer readable media.

55. The method for conducting the reliable exam according to claim 31, wherein the exam data received by the at least one server is validated for one or more of: data integrity, evidence of tampering, evidence of proctor bias, or evidence of examinee cheating.

56. The method for conducting the reliable exam according to claim 31, wherein the at least one answer received by the at least one server is one or more of: automatically graded against a predetermined answer key or is graded manually by a grader using a predetermined grading rubric.

57. The method for conducting the reliable exam according to claim 31, wherein the exam data received by the at least one server is validated and graded, such that one or more of the following feedback is made available for access by authorized users: at least one exam grade or exam statistics.

58. The method for conducting the reliable exam according to claim 31, wherein one or more of at least one exam grade or exam statistics are delivered from the at least one server to one or more of: webpages accessible by an authorized user, at least one predetermined email account, at least one text account, or at least one voicemail account associated with the authorized user.

59. The method for conducting the reliable exam according to claim 31, wherein prior to the step of preparing for the exam, the method further comprises a step of receiving a request from a customer for the exam to be one or more of scheduled or administered.

60. The method for conducting the reliable exam according to claim 59, wherein the method determines if the customer has at least one built exam by checking the server computer readable media for the at least one built exam associated with that customer;
wherein the at least one built exam comprises at least one question batch, wherein the at least one question batch comprises at a minimum at least one predetermined question up to a finite plurality of predetermined questions selected from a question bank.

61. The method for conducting the reliable exam according to claim 60, wherein if the customer has no of the at least one build exam stored in the server computer readable media, then the method presents an interactive exam building suite, as a web-based service, provided by the at least one server; wherein the at least one server receives inputs; wherein the inputs are used to build the at least one built exam.

62. The method for conducting the reliable exam according to claim 60, if the server computer readable media has the at least one built exam, then the method suggests one or more of: possible exam dates, exam times, projected number of examinees, and exam environment locations for the exam; or then the method requests one or more of: the possible exam dates, the exam times, the projected number of examinees, and the exam environment locations for the exam.

63. The method for conducting the reliable exam according to claim 62, wherein upon receipt of one or more of: the possible exam dates, the exam times, the projected number of examinees, and the exam environment locations for the exam, then method checks for proctor availability.

64. The method for conducting the reliable exam according to claim 63, wherein if at least one proctor is available, then the method schedules the exam for administration on the suggested or the received of the possible exam date, the exam time, the exam environment location, and the projected number of examinees.

65. The method for conducting the reliable exam according to claim 31, wherein prior to the step of conducting the exam, the method further comprises the step of receiving a request from an examinee to register for a scheduled examination; wherein receipt is from at least one computing-device in communication with the at least one server, accessing at least one web-based service provided by the at least one server.

66. The method for conducting the reliable exam according to claim 65, wherein upon receiving the request from the examinee to register for the scheduled examination, the method further comprises the step of registering the examinee by non-transitorily storing examinee information within the server computer readable media.
